(19) United States
(12) Patent Application Publication
(10) Pub. No.: US 2026/0295797 A1
(43) Pub. Date: Oct. 1, 2026

(54) POWER TOOL HAVING A HAMMER MECHANISM

(71) Applicant: MAKITA CORPORATION, Anjo-shi (JP)

(72) Inventors: Shinji ONODA, Anjo-shi (JP); Kazuki NAKAGAWA, Anjo-shi (JP)

(73) Assignee: MAKITA CORPORATION, Anjo-shi (JP)

(21) Appl. No.: 19/633,033

(22) Filed: Mar. 30, 2026

(30) Foreign Application Priority Data
Mar. 31, 2025 (JP) 2025-060059
Mar. 31, 2025 (JP) 2025-060060
Mar. 31, 2025 (JP) 2025-060061

(51) Int. Cl. B25D 17/24; B25D 17/04

(52) U.S. Cl. CPC B25D 17/24; B25D 17/043; B25D 2217/0073

(57) ABSTRACT

A power tool having hammer mechanism includes: driving body, having tool mounting portion to which tool accessory is mounted and motor; driving body housing formed by pair of split outer wall members that can be separated in dividing direction, wherein driving body housing includes rear-end side housing, grip portion on a rear-end portion, is connected to the driving body to move in front-rear direction relative to driving body; guide member that is connected to driving body housing while allowing driving body housing to move in front-rear direction; elastic mechanism that applies elastic force to driving body at one end portion of elastic mechanism in front-rear direction, while applying elastic force to driving body housing at other end portion; an engagement portion that is formed in inner wall surface of split outer wall member and configured to be engaged with other end portion of elastic mechanism.

### TECHNICAL FIELD

The present disclosure relates to a power tool having a hammer mechanism.

### BACKGROUND

A power tool having a hammer mechanism is configured to strike a workpiece by using a motor to drive a tool accessory mounted to a front end of the power tool. The power tool is used, for example, for chipping operation.

The power tool having a hammer mechanism typically includes a housing that houses a driving mechanism for driving a tool accessory and is connected to a grip portion configured to be held by a user. The housing may be configured as a vibration-isolating housing. The vibration-isolating housing reduces vibration that is transmitted from the driving mechanism to the grip portion during operation of the power tool, by utilizing an elastic force of an elastic element arranged inside the vibration-isolating housing.

For example, patent document 1 (Japanese Unexamined Patent Application Publication No. 2015-182167) discloses an electric hammer as a representative example of a power tool having a hammer mechanism and a vibration-isolating housing. In the electric hammer of patent document 1, the vibration-isolating housing is formed by a compression coil spring, which is an elastic element for isolating vibration, being held between a hand grip that is a grip portion and a body housing that houses the driving mechanism.

### SUMMARY

In the power tool having a hammer mechanism, it is preferable that split outer wall members forming the housing are configured such that internal components such as inside electrical components can be easily assembled. Further, in the power tool, it is preferable that the vibration-isolating housing using an elastic element as described above is easily configured.

The prior art power tool having a hammer mechanism still has room for improvement in ease of assembling internal components to the inside of the housing, and in a manner of configuring the vibration-isolating housing.

It is accordingly an object of the present disclosure to provide a power tool having a hammer mechanism that is configured such that internal components such as electrical components can be easily assembled, and a vibration-isolating housing can be easily configured.

In one aspect of the present disclosure, a power tool having a hammer mechanism is provided. The power tool of this aspect includes: a driving body, including a tool mounting portion at a front end and to which a tool accessory that is driven in a front-rear direction and strikes a workpiece is mounted, and a driving mechanism that includes a motor and drives the tool accessory and is arranged rearward of the tool mounting portion; a driving body housing, including: a rear-end side housing that is formed by a pair of split outer wall members that can be separated in a dividing direction orthogonal to the front-rear direction, and houses at least a rear-end portion of the driving body; and a grip portion that is provided on the rear-end portion and configured to be held by a user, wherein the driving body housing is connected to the driving body to move in the front-rear direction relative to the driving body; a guide member that guides movement of the driving body housing relative to the driving body in the front-rear direction, the guide member being fixed to the driving body along the front-rear direction within the driving body housing and connected to the driving body housing so as to allow the driving body housing to be movable in the front-rear direction; an elastic mechanism that is arranged within the rear-end side housing and includes an elastic element that generates an elastic force in the front-rear direction by elastically deforming when the driving body moves in the front-rear direction relative to the driving body housing, and applies the elastic force to the driving body at one end portion of the elastic mechanism in the front-rear direction, while applying the elastic force to the driving body housing at the other end portion; and an engagement portion that is provided on an inner wall surface of the split outer wall member and configured to be engaged with the other end portion of the elastic mechanism.

In the power tool according to this aspect, internal components such as electrical components can be easily assembled to the inside of the driving body housing while the split outer wall members that constitute the rear-end side housing are separated. Further, when the split outer wall members are connected in the dividing direction to form the rear-end side housing, the rear-end portion of the elastic mechanism can be easily fixed to the rear-end side housing by being engaged with the engagement portion formed in the inner wall surface of the split outer wall member. Thus, the rear-end side housing can be easily formed as a vibration-isolating housing.

### BRIEF DESCRIPTION OF THE DRAWINGS

FIG. 1 is a schematic perspective view of a power tool having a hammer mechanism.

FIG. 2 is a schematic exploded perspective view of the power tool.

FIG. 3 is a schematic side view of a driving body, with a rear-end side housing shown by broken line.

FIG. 4 is a schematic sectional view of the driving body, taken along line 4 -4 in FIG. 2.

FIG. 5 is a schematic perspective view showing elastic mechanisms provided in a rear-end portion of the driving body.

FIG. 6 is a schematic exploded perspective view of the elastic mechanisms.

FIG. 7 is a schematic view showing elastic deformation of the elastic mechanism.

FIG. 8A is a schematic perspective view of an engagement portion provided on an inner wall surface of the split outer wall member.

FIG. 8B is a schematic perspective view of the engagement portion with the elastic mechanism engaged therewith.

FIG. 9 is a schematic back view of the driving body as viewed from the rear.

FIG. 10 is a schematic view showing a flow of cooling air within a driving body housing.

FIG. 11 is a schematic perspective view of a passage member that forms a cooling air passage.

FIG. 12 is a schematic view showing elastic deformation of the passage member within the power tool.

FIG. 13 is a schematic perspective view of a groove-like wiring portion that forms a wiring route to the lighting portion.

FIG. 14 is a schematic perspective view of a ridge portion that is fitted in the groove-like wiring portion.

### DETAILED DESCRIPTION OF THE EMBODIMENTS

In one or more embodiments according to the present disclosure, the guide member may be formed of a shaft-like member, and the elastic element may be formed of a coil spring that is arranged around an outer periphery of the guide member and generates the elastic force by expanding and contracting in the front-rear direction.

According to this embodiment of the power tool, the guide member is integrated with the coil spring, so that the internal configuration of the power tool can be reduced in size and simplified. Further, the coil spring can expand and contract along the guide member while being supported by the guide member, so that the coil spring can smoothly expand and contract. Thus, the vibration-reducing effect of the elastic mechanism can be further enhanced.

In one or more embodiments according to the present disclosure, the elastic mechanism may include a tubular member that has a bore through which the guide member is inserted and that is configured to move along the guide member in contact with a rear end of the elastic element. The tubular member may constitute the other end of the elastic mechanism, and the engagement portion may be engaged with the tubular member of the elastic mechanism.

According to this embodiment, the elastic force for reducing vibration is appropriately applied in the front-rear direction to the rear-end side housing by the tubular member guided by the guide member. Further, the elastic mechanism is easily fixed to the rear-end side housing by engaging the engagement portion with the tubular member, so that the ease of assembling the elastic mechanism to the power tool is further improved. Thus, in the power tool, the vibration-isolating housing can be easily formed.

In one or more embodiments according to the present disclosure, an engaged portion of the tubular member that is engaged with the engagement portion may have substantially the same length in the front-rear direction as the length of the engagement portion in the front-rear direction.

According to this embodiment, the fixity of the tubular member to the engagement portion can be improved. Thus, the elastic mechanism is stably arranged in the rear-end side housing, so that the vibration-reducing effect of the elastic mechanism can be further enhanced.

In one or more embodiments according to the present disclosure, the engagement portion may define a groove that has a substantially semicircular cross-sectional shape opening in the dividing direction and extends in the front-rear direction, and the engagement portion may be configured to engage with the tubular member by receiving the tubular member within the groove in the dividing direction.

According to this embodiment, the tubular member can be more easily fitted into the engagement portion. Thus, in the power tool, the vibration-isolating housing can be even more easily configured.

In one or more embodiments according to the present disclosure, the tubular member may be arranged in the elastic mechanism while receiving the elastic force of the elastic element.

According to this embodiment, movement of the tubular member can be restricted by the elastic force of the elastic element in an initial state before the power tool starts driving. This can reduce or prevent rattling of the tubular member in the initial state. Further, the elastic force of the elastic element can be increased instantaneously when vibration is generated in the power tool. Thus, the vibration-reducing effect of the elastic mechanism can be further enhanced.

In one or more embodiments according to the present disclosure, the grip portion may have a columnar structure extending in an up-down direction orthogonal to the front-rear direction and a left-right direction orthogonal to the front-rear direction, at a center of the power tool in the left-right direction, and a plurality of the elastic mechanisms may be provided on both sides of the grip portion in the left-right direction.

According to this embodiment, the elastic force of the elastic mechanisms can be generated in a well-balanced manner on both the left and right sides of the grip portion. Thus, the vibration-reducing effect of the elastic mechanism can be further enhanced. Further, the power tool can be driven in a more stable posture.

In one or more embodiments according to the present disclosure, at least four such elastic mechanisms may be provided, and at least two of the elastic mechanisms may be arranged in the up-down direction on each of both sides of the grip portion in the left-right direction when viewed in the front-rear direction.

According to this embodiment, the elastic mechanisms are arranged in the left-right direction and the up-down direction in a well-balanced manner. Thus, the vibration-reducing effect of the elastic mechanisms is further enhanced, and the power tool is driven in a stabler attitude.

In one or more embodiments according to the present disclosure, the grip portion may have a columnar structure extending in an up-down direction orthogonal to the front-rear direction and to a left-right direction orthogonal to the front-rear direction, and the tool accessory, the motor and the grip portion may be arranged to overlap each other when viewed in the front-rear direction.

According to this embodiment, size increase of the power tool in the left-right direction and the up-down direction is restrained or avoided. Further, the tool accessory, the motor and the grip portion are arranged in alignment in the front-rear direction, so that the elastic force of the elastic element in the front-rear direction is effectively applied in a direction of enhancing the vibration-reducing effect.

In one or more embodiments according to the present disclosure, a rotational axis of the motor may extend in the up-down direction along with the grip portion.

According to this embodiment, the motor can be easily accommodated within the vertical extent of the grip portion. Thus, the power tool can be made more compact in configuration.

In one or more embodiments according to the present disclosure, a battery mounting portion to which a battery for supplying power to the motor is mounted is provided on the driving body housing.

According to this embodiment, vibration generated during operation and transmitted to the battery can be suppressed. Thus, occurrence of problems such as detachment of the battery or damage to the battery due to vibration can be suppressed.

Hereinafter, representative and non-limiting embodiments of the present disclosure will be described in detail with reference to the drawings.

### 1. EMBODIMENT

### 1-1. General Configuration of Power Tool

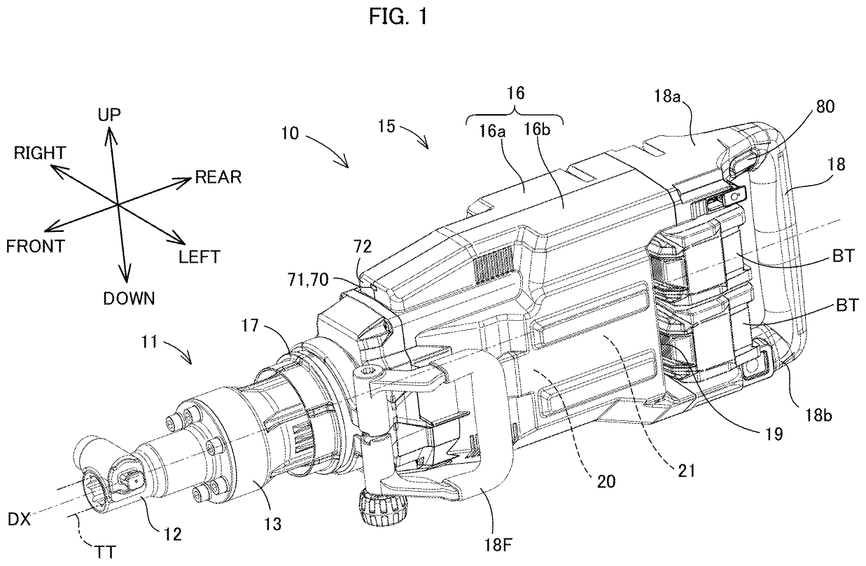

First, a general configuration of a power tool 10 having a hammer mechanism (also referred to as a striking mechanism) according to an embodiment of the present disclosure will be described with reference to FIG. 1. In FIG. 1, arrows indicate three directions orthogonal to each other relating to the power tool 10, which are defined for convenience of description in this specification: a “front-rear direction”, an “up-down direction” and a “left-right direction.”

The “front-rear direction” corresponds to the longitudinal direction of the power tool 10. In the front-rear direction, the side on which a tool accessory TT is mounted is the front side, and the side on which a grip portion 18 is arranged is the rear-end side. The “front-rear direction” also corresponds to the “driving direction” in which the tool accessory TT of the power tool 10 is reciprocatingly driven. The “up-down direction” is orthogonal to the front-rear direction. In the power tool 10 of the present embodiment, the up-down direction corresponds to the direction in which the grip portion 18, to be described later, extends. The “left-right direction” is orthogonal to the front-rear direction and the up-down direction.

The arrows that show the three directions of the front-rear direction, the up-down direction and the left-right direction, are appropriately shown in the other drawings in this specification so as to correspond to those in FIG. 1. The “up” and “down” and the “left” and “right” in the “up-down direction” and the “left-right direction” are used as concepts indicating opposite directions to each other, and do not limit a use posture or an arrangement posture of the power tool 10.

The power tool 10 is a type of hand-held power tool. In the present embodiment, the power tool 10 is a striking tool (e.g., an electric hammer) and is used, for example, for chipping operation. The power tool 10 is configured to strike a workpiece (not shown) by driving the tool accessory TT mounted to a front end thereof, in the front-rear direction on a driving axis DX, which will be described later and is shown by a dash-dotted line in FIG. 1, using a driving force of a motor 21. The tool accessory TT is a so-called hammer bit, and is formed of, for example, a shaft-shaped steel material having a tip end with reduced diameter. In FIG. 1, for convenience, only the position of a base end portion of the tool accessory TT when mounted to the power tool 10 is shown by two-dot chain lines.

The power tool 10 includes a driving body 11 for driving the tool accessory TT. The driving body 11 has, a front end thereof, a tool mounting portion 12 to which the tool accessory TT is mounted. The tool mounting portion 12 has a cylindrical configuration opening toward the front such that the tool accessory TT can be inserted therein. A central axis of the tool mounting portion 12 coincides with the driving axis DX. The tool mounting portion 12 is configured such that the tool accessory TT can be fixed and released by user's operation.

The driving body 11 further includes a driving shaft portion 13 extending axially in the front-rear direction on the front side, and a driving mechanism 20 arranged on a rear-end side of the driving shaft portion 13 and connected to the driving shaft portion 13. The tool mounting portion 12 is provided at a front end of the driving shaft portion 13. A central axis of the driving shaft portion 13 corresponds to the driving axis DX of the power tool 10. The driving shaft portion 13 includes therein a mechanism for transmitting a driving force for driving the tool accessory TT to the tool mounting portion 12. The driving mechanism 20 includes the motor 21, and transmits the driving force generated by the motor 21 to the driving shaft portion 13. The configuration of the driving body 11, including the driving shaft portion 13 and the driving mechanism 20, will be described later.

The power tool 10 has a driving body housing 15 that is arranged on a rear-end side of the tool mounting portion 12 and houses and holds a portion of the driving body 11. The driving body housing 15 has a rear-end side housing 16 that forms a portion of the exterior of the power tool 10, and a front-side housing 17. The rear-end side housing 16 houses at least a rear-end portion of the driving body 11 in a front portion of the rear-end side housing 16. The front-side housing 17 is connected to a front end portion of the rear-end side housing 16, and houses a portion of the driving body 11. In the present embodiment, the driving shaft portion 13 of the driving body 11 protrudes forward from a front end portion of the front-side housing 17.

The driving body housing 15 includes a grip portion 18 to be held by a user. The grip portion 18 is provided at a rear end of the rear-end side housing 16. The grip portion 18 is configured as a columnar portion that extends in the up-down direction and intersects the driving axis DX. The grip portion 18 has such a thickness as to be held by user.

The grip portion 18 is connected to a rear end of the rear-end side housing 16 via a pair of connecting end portions 18a, 18b that are provided at both ends of the grip portion 18 in the up-down direction and extend forward. In the present embodiment, an operation switch portion 80 is provided on a side surface of the upper connecting end portion 18a. The operation switch portion 80 will be described later.

In the present embodiment, the driving body housing 15 functions as a vibration-isolating housing of the power tool 10. The driving body housing 15 is connected to the driving body 11 so as to be movable relative to the driving body 11 by a prescribed distance in the front-rear direction, and reduces vibration transmitted from the driving body 11 to the grip portion 18 during operation of the power tool 10, by utilizing an elastic force of an elastic element described later. The configuration for allowing the driving body housing 15 to function as the vibration-isolating housing will be described later.

In the present embodiment, a front-side grip portion 18F configured to be held by a user is mounted to the driving body housing 15. The front-side grip portion 18F is mounted on a cylindrical portion on a front side of the front-side housing 17. Since the driving body housing 15 serves as a vibration-isolating housing, vibration transmitted from the driving body 11 to the front-side grip portion 18F is also reduced. Note that a length of a columnar portion of the front-side grip portion 18F to be held by the user is smaller than a length of the grip portion 18 in the up-down direction. The front-side grip portion 18F is configured to be removable from the power tool 10. The front-side grip portion 18F is pivotable in a lever-like manner in the front-rear direction relative to a mounting position on the front-side housing 17. Further, a mounting position of the front-side grip portion 18F is adjustable around the driving axis DX.

A battery mounting portion 19 to which a battery BT is removably mounted as power supply of the power tool 10 is provided on the driving body housing 15. The battery mounting portion 19 is provided on a rear-end portion of the rear-end side housing 16 and located in front of the grip portion 18. The battery BT is mounted on the battery mounting portion 19 between the rear-end side housing 16 and the grip portion 18. In the present embodiment, two batteries BT are mounted to the battery mounting portion 19 in a state of being arranged adjacent to each other in the up-down direction.

With the configuration in which the battery mounting portion 19 is provided on the driving body housing 15 functioning as a vibration-isolating housing, vibration generated during operation can be suppressed from being transmitted to the battery BT. Therefore, it is possible to suppress occurrence of malfunctions, such as detachment of the battery BT, damage to the battery BT, or disconnection of connection wiring for the battery BT due to vibration.

The power tool 10 has a lighting portion 70 that emits illumination light for improving visibility for user during work. The lighting portion 70 has a light-emitting element 71 provided at a position where light can be irradiated toward a workpiece. In the present embodiment, the light-emitting element 71 is provided on an outer wall surface 72 that is provided at an upper end in the up-down direction and faces forward a front side. Details of the lighting portion 70 will be described later.

### 1-2. General Configurations of Driving Body Housing and Driving Body

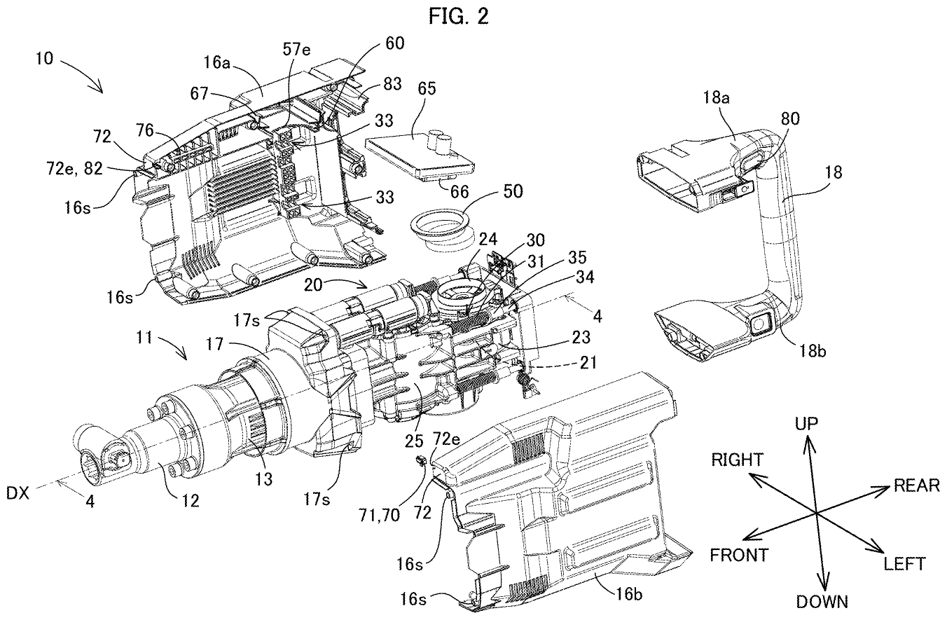

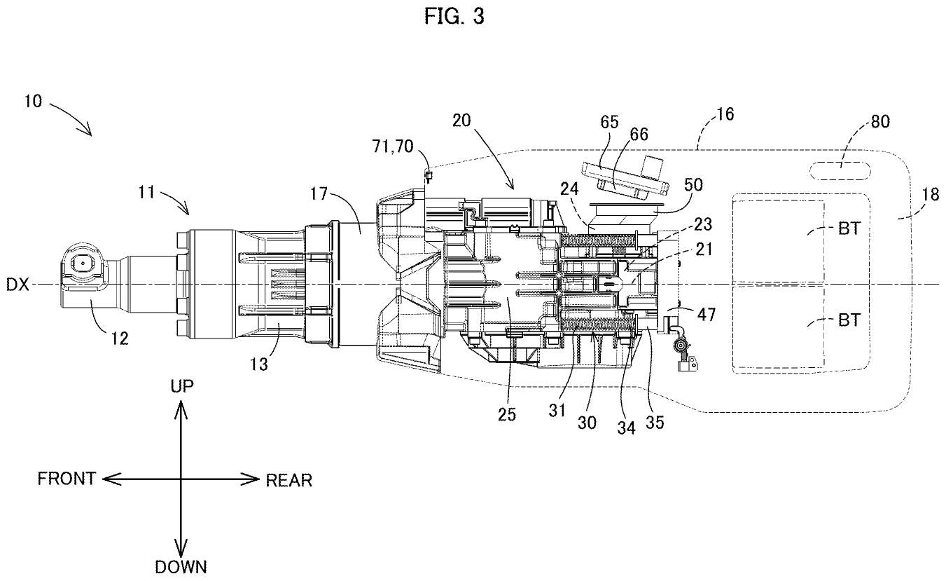

With reference to FIGS. 2 and 3, general configurations of the rear-end side housing 16 of the driving body housing 15, the driving body 11, and the front-side housing 17 of the driving body housing 15 will be described in this order. In FIG. 2, for convenience, illustration of the front-side grip portion 18F and the batteries BT is omitted. Further, FIG. 2 illustrates a state in which the front-side housing 17 is attached to the driving body 11. In FIG. 3, for convenience, the driving body 11 and the front-side housing 17 are indicated by solid lines, and the rear-end side housing 16 and the batteries BT are indicated by dashed lines.

First, the general configuration of the rear-end side housing 16 will be described.

As shown in FIG. 2, an outer wall member forming the rear-end side housing 16 is configured as a pair of split outer wall members 16a, 16b that are separable in a dividing direction orthogonal to the front-rear direction. In the present embodiment, the dividing direction of the split outer wall members 16a, 16b corresponds to the left-right direction. The position of a division boundary between the split outer wall members 16a, 16b corresponds to the center of the rear-end side housing 16 in the left-right direction. The first split outer wall member 16a forms a right side surface of the power tool 10, and the second split outer wall member 16b forms a left side surface of the power tool 10.

The rear-end side housing 16 that covers a side surface of a rear-end portion of the driving body 11 is configured by holding the rear-end portion of the driving body 11 between the pair of split outer wall members 16a, 16b in the dividing direction and joining the pair of split outer wall members 16a, 16b. After the rear-end side housing 16 is configured, the driving body housing 15 is configured by connecting the front-side housing 17 from a front-side and connecting the grip portion 18 from a rear-end side.

In the power tool 10, the internal structure can be accessed by separating the split outer wall members 16a, 16b. Therefore, for example, mounting of internal components such as electrical components is facilitated. Examples of the electrical components include a control board having an integrated circuit and forming a control unit 65 (also referred to as a controller) of the power tool 10, the light-emitting element 71 and electrical wiring of the lighting portion 70, and electrical wiring connected to the battery mounting portion 19 and the operation switch portion 80, and various electronic circuits and circuits elements.

Further, as will be described later, in the power tool 10, since the rear-end side housing 16 is configured by the pair of split outer wall members 16a, 16b, fixing an elastic element for forming the vibration-isolating housing to the rear-end side housing 16 is facilitated. Thus, the vibration-isolating housing can be easily configured. Although not shown, in order to form the vibration-isolating housing, a restriction portion is provided inside the rear-end side housing 16 and defines a range of movement of the driving body housing 15 relative to the driving body 11 by abutting against the driving body 11.

Inside the rear-end side housing 16, cooling air passage for introducing cooling air into the driving body 11 is configured. In the present embodiment, the cooling air passage is configured to introduce the cooling air to a motor accommodation portion 23 of the driving body 11. In the power tool 10, since the rear-end side housing 16 is configured by the pair of split outer wall members 16a, 16b, assembly of a passage member 50 forming the cooling air passage is facilitated. Further, as will be described later, in the power tool 10 of the present embodiment, a control board constituting the above-described control unit 65 is disposed in the cooling air passage, and mounting of the control unit 65 into the cooling air passage is also facilitated. FIG. 3 illustrates arrangement positions of the passage member 50 and the control unit 65 within the driving body housing 15. Details of the cooling air passage will be described later.

As described above, the power tool 10 is provided with the lighting portion 70 having the light-emitting element 71. FIG. 3 illustrates an arrangement position of the light-emitting element 71 within the rear-end side housing 16 of the driving body housing 15. In the power tool 10, since the rear-end side housing 16 is configured by the pair of split outer wall members 16a, 16b, arrangement of the light-emitting element 71 and electrical wiring (not shown) connected to the light-emitting element 71 is facilitated. Details of the lighting portion 70 will be described later.

Next, the general configuration of the driving body 11 will be described.

As shown in FIG. 2, the motor accommodation portion 23 that houses the motor 21 of the driving mechanism 20 is provided at a rear-end portion of the driving body 11. At an upper end of the motor accommodation portion 23, a communication port 24 is formed so as to communicate with an internal space of the motor accommodation portion 23. As shown in FIG. 3, the passage member 50 forming the cooling air passage, which will be described later, is mounted to the communication port 24.

In the power tool 10, the tool mounting portion 12, the motor accommodation portion 23 and the grip portion 18 are arranged to overlap each other when viewed in the front-rear direction. The battery mounting portion 19 is provided between the motor accommodation portion 23 and the grip portion 18. This configuration realizes the rechargeable power tool 10 that is compact and hand-held.

The driving body 11 has a transmission mechanism 25 that is provided on a front side of the motor accommodation portion 23 and configured to transmit the driving force of the motor 21 to the driving shaft portion 13. The transmission mechanism 25 constitutes the driving mechanism 20 together with the motor 21. In the power tool 10, the driving shaft portion 13, the transmission mechanism 25, and the motor 21 are arranged in a line on the driving axis DX. Internal configurations of the driving shaft portion 13 and the driving mechanism 20 will be described later.

The driving body 11 is provided with an elastic mechanism 30 for allowing the driving body 11 to function as a vibration-isolating housing. In the present embodiment, a plurality of elastic mechanisms 30 are provided on a side surface portion of the rear-end portion of the driving body 11. Each of the elastic mechanisms 30 has an elastic element 31 that elastically deforms when the driving body 11 moves in the front-rear direction relative to the rear-end side housing 16 of the driving body housing 15, and generates an elastic force in the front-rear direction to oppose the direction of this movement.

In the present embodiment, the elastic mechanism 30 is fixed at its front-side end to the driving body 11, so that the elastic force of the elastic element 31 can be applied to the driving body 11. Further, a rear-end portion of the elastic mechanism 30 is fixed at its rear-end side to an inner wall surface of the split outer wall member 16a or 16b, so that an elastic force can be applied to the driving body housing 15.

As will be described later, the rear-end side end of the elastic mechanism 30 is fixed to the split outer wall members 16a, 16b by being fitted and engaged in the dividing direction with an engagement portions 33 provided on an inner wall surface of the pair of split outer wall members 16a, 16b. In the present embodiment, a tubular member 35 constituting the rear-end side end of the elastic mechanism 30 is engaged with the engagement portions 33. Details of the elastic mechanisms 30 and the engagement portions 33 of the split outer wall members 16a, 16b will be described later.

A guide member 34 that constitutes a guide mechanism for guiding movement of the driving body housing 15 relative to the driving body 11 in the front-rear direction, when the driving body housing 15 moves as the vibration-isolating housing, is fixed to the driving body 11. In the present embodiment, the guide member 34 is provided on a side surface portion of the rear-end portion of the driving body 11. Further, in the present embodiment, the guide mechanism constituted by the guide member 34 is integrated with the elastic mechanism 30 and forms part of the elastic mechanism 30. Details of the guide member 34 will be described later together with the elastic mechanism 30.

Next, the front-side housing 17 of the driving body housing 15 will be described. The front-side housing 17 houses the rear-end portion of the driving shaft portion 13 and a front-side portion of the transmission mechanism 25. The front-side housing 17 is connected to the front-side portion of the rear-end side housing 16, as described above. As shown in FIG. 2, the front-side housing 17 is provided with through holes 17s through which screws for connection with the rear-end side housing 16 are inserted. Further, the rear-end side housing 16 is provided with threaded holes 16s with which front-end portions of the screws inserted through the through holes 17s are threadedly engaged. The front-side housing 17 constitutes part of the vibration-isolating housing by being connected to the rear-end side housing 16. As described above, since the front-side grip portion 18F is attached to the front-side housing 17, transmission of vibration during operation is suppressed.

### 1-3. Internal Mechanisms of Driving Body

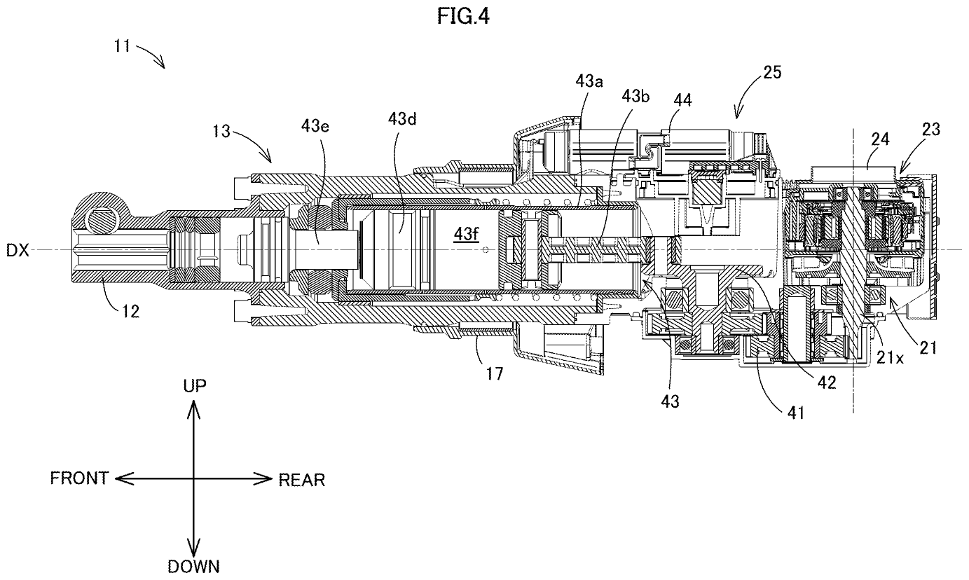

The internal mechanisms of the driving mechanism 20 and the driving shaft portion 13 in the driving body 11 will be described with reference to FIG. 4.

As described above, the driving mechanism 20 includes the motor 21 and the transmission mechanism 25. In the present embodiment, a rotational axis 21x of the motor 21 is arranged along the up-down direction so as to intersect the driving axis DX. As can be understood from FIGS. 2, 3 and 4, the rotational axis 21x of the motor 21 extends in the up-down direction similarly to the grip portion 18 and extends substantially in parallel to the grip portion 18. With this configuration, while a dimension of an arrangement area of the motor 21 is reduced, the arrangement area of the motor 21 can be easily accommodated within a region in the up-down direction in which the grip portion 18 extends. Therefore, the arrangement area of the motor 21 in the power tool 10 can be efficiently secured, and the power tool 10 can be compactly configured.

The transmission mechanism 25 includes a reduction gear 41 connected to the motor 21, and a motion converting mechanism 42 connected to the reduction gear 41. The reduction gear 41 is arranged below the driving axis DX and connected to a lower end of the rotational axis 21x of the motor 21. The reduction gear 41 has a plurality of gears, and is configured to adjust torque of rotational motion transmitted from the rotational axis 21x of the motor 21 by a combination of the gears and transmit the rotational motion to the motion converting mechanism 42.

The motion converting mechanism 42 is arranged in front of the motor 21 and above the reduction gear 41, in an area through which the driving axis DX passes. The motion converting mechanism 42 has a crank gear and is configured to convert rotational motion transmitted from the reduction gear 41 into reciprocating linear motion in a direction along the driving axis DX and transmit the reciprocating linear motion to the driving shaft portion 13.

The driving shaft portion 13 includes therein a striking mechanism 43 that drives a tool accessory TT, and a dynamic vibration reducer 44 that oscillates to cancel vibration caused by driving of the tool accessory TT. The driving force for reciprocating linear motion is transmitted from the motion converting mechanism 42 to each of the striking mechanism 43 and the dynamic vibration reducer 44. Hereinafter, the striking mechanism 43 and the dynamic vibration reducer 44 will be described in this order.

The striking mechanism 43 includes a cylinder 43a, a connecting rod 43b, a piston 43c, a striking element (also referred to as striker) 43d and an impact bolt 43e. The cylinder 43a is formed by a cylindrical member open at both ends. The cylinder 43a is arranged such that its central axis coincides with the driving axis DX. Inside the cylinder 43a, the connecting rod 43b, the piston 43c and the striker 43d are arranged in this order from the rear-end side toward the front side.

The connecting rod 43b is arranged such that its central axis coincides with the driving axis DX. A rear-end portion of the connecting rod 43b is connected to the motion converting mechanism 42, and a front end portion of the connecting rod 43b is connected to the piston 43c. The piston 43c is arranged within the cylinder 43a with its side surface in airtight contact with an inner wall surface of the cylinder 43a. The piston 43c reciprocates in the front-rear direction within the cylinder 43a by a driving force transmitted from the motion converting mechanism 42 via the connecting rod 43b.

The striker 43d is formed by a cylindrical member and arranged within the cylinder 43a such that its central axis coincides with the driving axis DX. The striker 43d is arranged within a front-side space of the cylinder 43a with its side surface in airtight contact with the inner wall surface of the cylinder 43a. The striker 43d is movable in the front-rear direction within the cylinder 43a.

An air chamber 43f is formed between the striker 43d and the piston 43c so as to function as an air spring. A driving force is transmitted from the piston 43c to the striker 43d via the air in the air chamber 43f.

The impact bolt 43e is held on front side of the cylinder 43a. The central axis o the impact bolt 43e coincides with the driving axis DX. A front-end portion of the impact bolt 43e is connected to a rear-end portion of the tool mounting portion 12. A rear-end portion of the impact bolt 43e is inserted into the cylinder 43a so as to be contactable with a front end portion of the striker 43d.

The striker 43d moves along the driving axis DX by the driving force transmitted from the piston 43c via the air chamber 43f and strikes the rear-end portion of the impact bolt 43e. The impact force generated on the impact bolt 43e by the striking is transmitted to a rear-end portion of the tool accessory TT mounted to the tool mounting portion 12, whereby the tool accessory TT strikes the workpiece.

The dynamic vibration reducer 44 is arranged above the motion converting mechanism 42. The dynamic vibration reducer 44 includes a compression coil spring and a weight. The dynamic vibration reducer 44 actively vibrates the weight, by a driving force transmitted from the motion converting mechanism 42 via the compression coil spring, so as to cancel the vibration generated in the striking mechanism 43. In the power tool 10, since the dynamic vibration reducer 44 is provided, vibration generated during operation is suppressed.

### 1-4. Elastic Mechanism for Configurating Vibration-Isolating Housing

### 1-4-1. Configuration of Elastic Mechanism

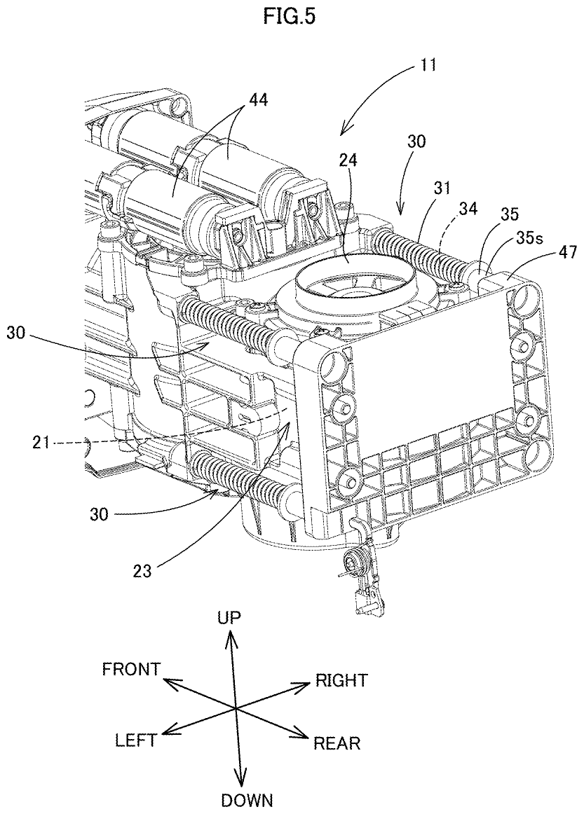

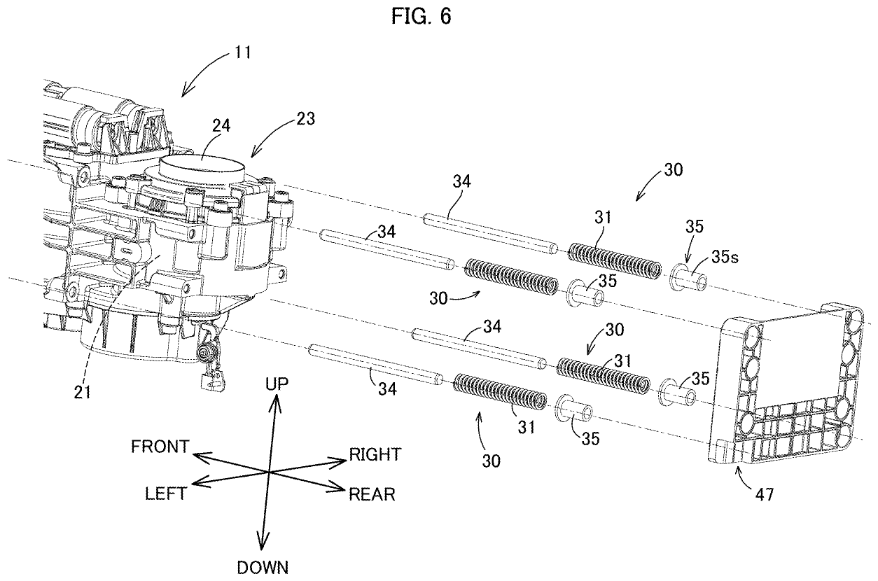

The configuration of the elastic mechanism 30 provided inside the rear-end side housing 16 of the power tool 10 will be described with reference to FIGS. 5 and 6.

As described above, the power tool 10 includes the elastic mechanism 30 for causing the driving body housing 15 to function as a vibration-isolating housing. Further, as described above, in the present embodiment, the elastic mechanism 30 is integrated with a guide mechanism that guides the movement of the driving body housing 15 in the front-rear direction relative to the driving body 11. The guide member 34 that constitutes the guide mechanism also constitutes a part of the elastic mechanism 30. Below, the configuration of the guide mechanism using the guide member 34 will be described first, followed by a description of the configuration of the elastic mechanism 30.

The guide member 34 is arranged along the front-rear direction on a side surface portion of the driving body 11. In the present embodiment, the guide member 34 is formed by a shaft-like member. Further, in the present embodiment, a plurality of guide members 34 are arranged in parallel to each other so as to surround the side surface portion of the driving body 11 about the driving axis DX. The guide members 34 are arranged around the motor accommodation portion 23 at the rear-end portion of the driving body 11. More specifically, four guide members 34 are provided and arranged at four corner portions (upper, lower, left, and right) around the motor accommodation portion 23.

Front-end and rear-end portions of the guide member 34 are fixed to the driving body 11. As shown in FIG. 6, the front-end portion of the guide member 34 is inserted into and fixed to a hole provided in a wall surface of the driving body 11 that faces toward the rear-end side. The rear-end portion of the guide member 34 is inserted into and fixed to a hole provided in a rectangular plate-like base member 47 fixed to a rear-end portion of the motor accommodation portion 23 of the driving body 11.

The driving body housing 15 is connected to the guide member 34 fixed to the driving body 11 so as to be movable in the front-rear direction. In the present embodiment, the driving body housing 15 is connected to the guide member 34 via a tubular member 35. The tubular member 35 is a component that constitutes the guide mechanism.

The tubular member 35 includes a cylindrical body portion 35s. At a front-end portion of the cylindrical body portion 35s, an annular flange 35e having a larger diameter than the cylindrical body portion 35s is provided. A bore (through-hole) extending along a central axis is formed in the cylindrical body portion 35s. By inserting the guide member 34 into the bore, the tubular member 35 is mounted to the guide member 34 such that the tubular member 35 is slidable in the front-rear direction along the guide member 34.

The driving body housing 15 is connected to the guide member 34 by the engagement of the engagement portions 33, which are provided on inner wall surfaces of split outer wall members 16a, 16b shown in FIG. 2, with the cylindrical body portion 35s of the tubular member 35. Accordingly, the driving body housing 15 is movable in the front-rear direction relative to the driving body 11 while being guided by the guide member 34.

The tubular member 35 can be formed of a resin material. It is preferable that the tubular member 35 is formed of a material having a low friction coefficient so as to smoothly slide relative to the guide member 34. The tubular member 35 can be formed of, for example, polyacetal resin (POM resin).

Next, the elastic mechanism 30 will be described. As described above, the elastic mechanism 30 includes an elastic element 31 that elastically deforms when the driving body housing 15 moves in the front-rear direction relative to the driving body 11, and generates an elastic force in the front-rear direction in a direction opposite to the movement direction. The elastic element 31 is installed in the driving body 11 such that it can apply an elastic force to the driving body 11 at a front-end portion thereof. Further, the elastic element 31 is fixed to the rear-end side housing 16 of the driving body housing 15 such that it can apply an elastic force to the driving body housing 15 at a rear-end portion thereof. Accordingly, vibration that is transmitted from the driving body 11 to the grip portion 18 of the driving body housing 15 during operation of the power tool 10 can be absorbed and reduced by the elastic force of the elastic element 31.

It is preferable that the elastic element 31 is arranged inside the driving body housing 15 in a state where it generates an elastic force in the front-rear direction. In the present embodiment, the elastic element 31 is assembled to the elastic mechanism 30 while being compressed (from its free length). According to this configuration, movement of the tubular member 35 is suppressed by the elastic force of the elastic element 31 in an initial state before the power tool 10 is driven. This suppresses rattling of the tubular member 35 in the initial state. Further, the elastic force of the elastic element 31 can be instantaneously increased when vibration is generated in the power tool 10. Thus, the vibration-reducing effect of the elastic mechanism 30 can be further enhanced.

In the present embodiment, the elastic element 31 is formed of a compression coil spring and is arranged such that a longitudinal direction of elastic deformation of the elastic element 31 is the front-rear direction. The elastic element 31 is arranged around an outer periphery of the guide member 34. The elastic element 31 is installed so as to be wound around the outer periphery of the guide member 34.

The elastic element 31 is arranged such that the front-end portion of the elastic element 31 contacts with the driving body 11 in a state where the elastic element 31 is held by the guide member 34. Accordingly, the elastic mechanism 30 can apply the elastic force of the elastic element 31 to the driving body 11 at the front-end portion. Further, the elastic element 31 is arranged such that the rear-end portion of the elastic element 31 contacts with a front-end portion of the tubular member 35. Accordingly, the elastic mechanism 30 can apply the elastic force of the elastic element 31 to the driving body housing 15 via the tubular member 35 that constitutes a rear-end portion of the elastic mechanism 30.

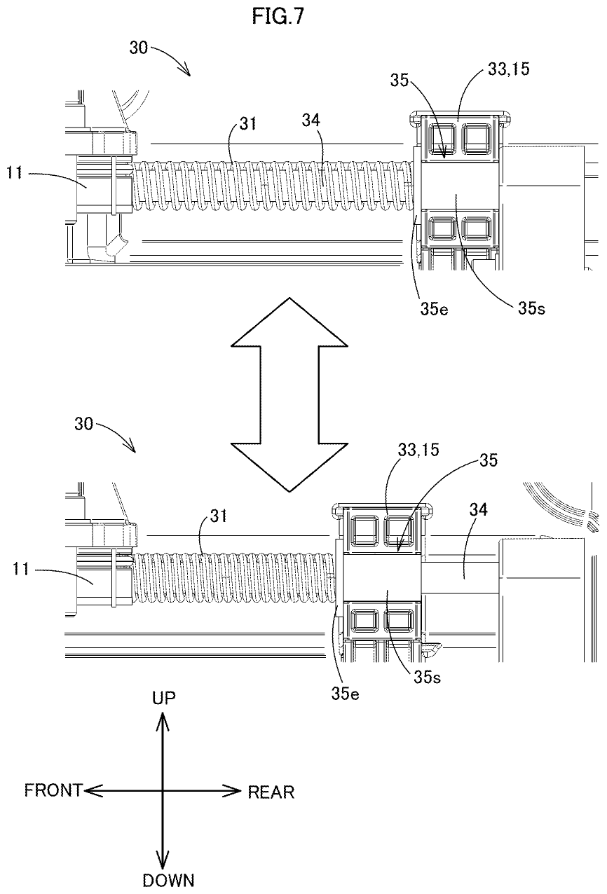

Reference is made to FIG. 7. The upper section of FIG. 7 shows a state in which the driving body housing 15 is moved to a rear-end limit position relative to the driving body 11. The state shown in the upper section of FIG. 7 is also an initial state of the power tool 10 before start of driving. The lower section of FIG. 7 shows a state in which the driving body housing 15 is moved to a front-end limit position relative to the driving body 11.

When the driving body housing 15 moves rearward relative to the driving body 11, the elastic element 31 extends, and the tubular member 35 moves rearward along the guide member 34 while being engaged with the engagement portions 33 of the rear-end side housing 16. When the driving body housing 15 moves forward relative to the driving body 11, the elastic element 31 contracts, and the tubular member 35 moves forward along the guide member 34 while being engaged with the engagement portions 33 of the rear-end side housing 16.

In this manner, according to the elastic mechanism 30 of the present embodiment, the elastic deformation of the elastic element 31 is smoothed by being guided by the guide member 34. Thus, the vibration-reducing effect of the elastic mechanism 30 can be further enhanced. Further, according to the elastic mechanism 30 of the present embodiment, since the movement of the tubular member 35 in the front-rear direction is guided by the guide member 34, the elastic force of the elastic element 31 can be appropriately applied to the rear-end side housing 16.

Further, if the tubular member 35 constitutes the rear-end portion of the elastic mechanism 30, as described below, fixing of the elastic mechanism 30 to the engagement portions 33 of the split outer wall members 16a, 16b can be facilitated. Thus, the assemblability of the elastic mechanism 30 to the power tool 10 can be further enhanced.

### 1-4-2. Engagement Portions of Driving Body Housing

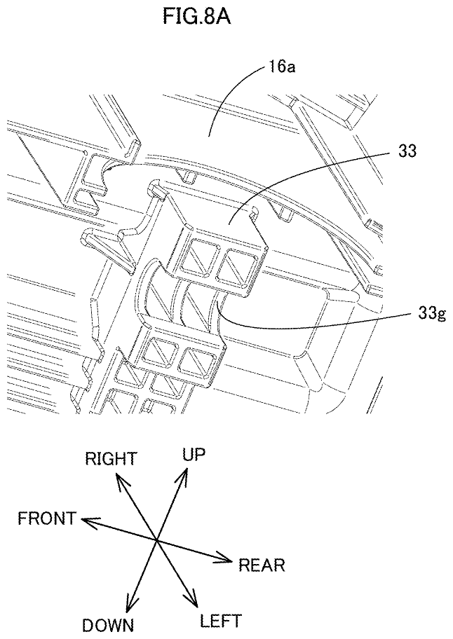

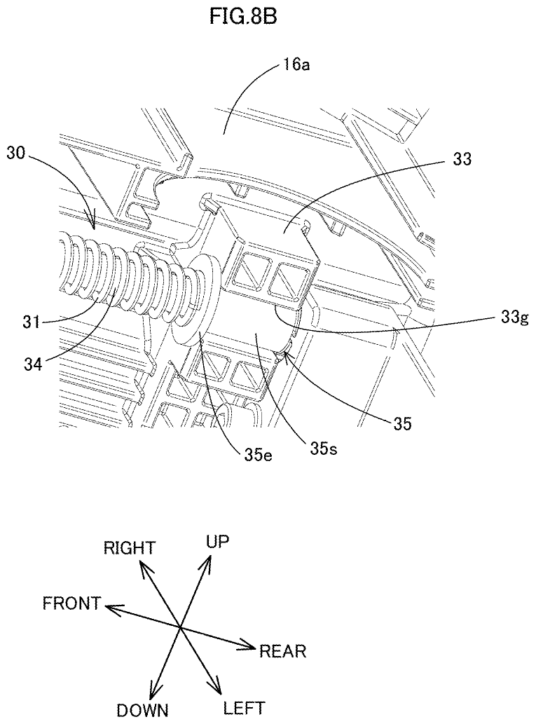

With reference to FIGS. 2, 8A and 8B, the configuration of the engagement portions 33 of the driving body housing 15 will be described. FIG. 8A shows a state before the tubular member 35 of the elastic mechanism 30 is engaged with the engagement portions 33, and FIG. 8B shows a state after the tubular member 35 is engaged with the engagement portions 33.

As shown in FIG. 2, the engagement portions 33 are provided on the inner wall surfaces of the pair of split outer wall members 16a, 16b constituting the rear-end side housing 16 of the driving body housing 15, at positions corresponding to the rear-end portion of the elastic mechanism 30. As shown in FIG. 8A, each engagement portion 33 includes a groove 33g that has a substantially semicircular cross-sectional shape open in a dividing direction and extends in the front-rear direction. As shown in FIG. 8B, the engagement portions 33 engage with the tubular member 35 by receiving the cylindrical body portion 35s of the tubular member 35 inside the groove 33g in the dividing direction.

In the power tool 10 according to the present embodiment, when the rear-end side housing 16 is formed by connecting the pair of split outer wall members 16a, 16b in the dividing direction, the tubular member 35 constituting the rear-end portion of the elastic mechanism 30 can be fitted and engaged with the engagement portions 33 in the dividing direction. Accordingly, since the rear-end portion of the elastic mechanism 30 can be easily fixed to the rear-end side housing 16, the rear-end side housing 16 can be easily configured as a vibration-isolating housing.

Furthermore, according to the configuration of the engagement portions 33 having the grooves 33g, the tubular member 35 can be even more easily fitted and engaged in the dividing direction. Accordingly, the vibration-isolating housing of the power tool 10 can be configured more simply.

The length of the engagement portions 33 in the front-rear direction is substantially the same as a length of the cylindrical body portion 35s, which is a portion of the tubular member 35 to be engaged with the engagement portions 33, in the front-rear direction. With this configuration, the fixability of the tubular member 35 to the engagement portions 33 can be enhanced. Accordingly, the elastic mechanism 30 can be suppressed from becoming unstable in the rear-end side housing 16, and the vibration-reducing effect of the elastic mechanism 30 can be further enhanced. Further, the diameter of the semicircular grooves 33g of the engagement portions 33 is substantially the same as or slightly smaller than the diameter of the cylindrical body portion 35s. According to this configuration, the fixability of the tubular member 35 to the engagement portions 33 can be enhanced.

As described above, in the present embodiment, the flange 35e is provided on the front-end portion of the tubular member 35. Since the flange 35e can support the end portion of the elastic element 31 compressed to be shorter than its free length, the cylindrical body portion 35s of the tubular member 35 can be easily engaged with the engagement portions 33 while the elastic element 31 remains compressed. Further, the flange 35e serves as a locking portion that is locked to a side surface of the engagement portions 33. Accordingly, the elastic force of the elastic element 31 can be more reliably transmitted to the driving body housing 15 via the engagement portions 33. In addition, the flange 35e also serves as a positioning portion when the tubular member 35 is engaged with the engagement portions 33.

### 1-4-3. Arrangement Configuration of the Elastic Mechanism

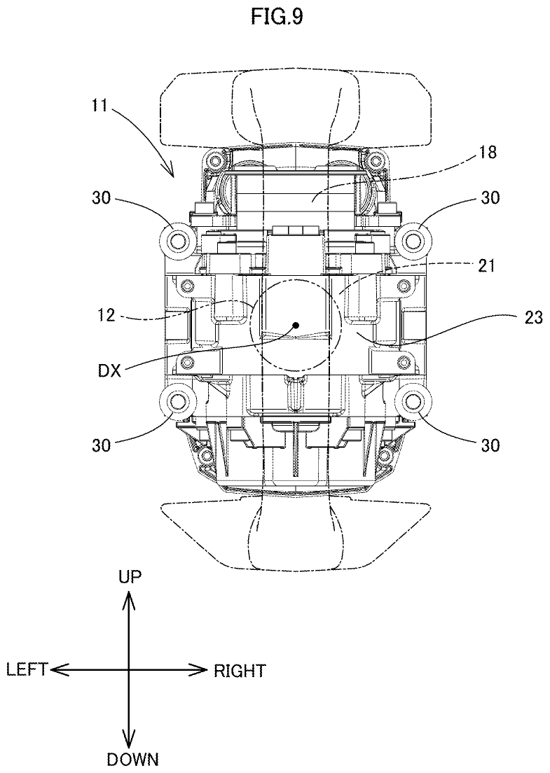

Reference is made to FIG. 9. FIG. 9 illustrates the rear-end portion of the driving body 11 with the base member 47 omitted. An arrangement region of the grip portion 18 is shown by a dot-dash line, and the arrangement region of the tool mounting portion 12 is shown by a two-dot chain line, superimposed on the driving body 11.

In the present embodiment, a plurality of elastic mechanisms 30 are provided. As shown in FIG. 9, the elastic mechanisms 30 are provided on both sides of the grip portion 18 in the left-right direction. Preferably, the elastic mechanisms 30 are arranged substantially symmetrically in the left-right direction with respect to the grip portion 18 when the power tool 10 is viewed in the front-rear direction. According to this configuration, the elastic forces of the elastic mechanisms 30 can be generated in a well-balanced manner on both sides of the grip portion 18 in the left-right direction. Accordingly, the vibration-reducing effect of the elastic mechanisms 30 is further enhanced. Further, the power tool 10 can be driven in a more stable posture.

It is preferable that at least four elastic mechanisms 30 are provided, and at least two of the elastic mechanisms 30 are arranged in the up-down direction on both sides of the grip portion 18 in the left-right direction. According to this configuration, since the plurality of elastic mechanisms 30 can be arranged in a well-balanced manner in the left-right direction and the up-down direction, the power tool 10 can be driven in a more stable posture. In the present embodiment, four elastic mechanisms 30 are provided, and two of the elastic mechanisms 30 are arranged in the up-down direction on each side of the grip portion 18 in the left-right direction. With this configuration, the elastic mechanisms 30 can be arranged in a well-balanced manner around the tool accessory TT mounted to the tool mounting portion 12, while significant increase in the number of the elastic mechanisms 30 is suppressed. Accordingly, the vibration-reducing effect can be further enhanced with a small number of the elastic mechanisms 30. It is preferable that the plurality of elastic mechanisms 30 are arranged so as to surround the tool mounting portion 12 when the power tool 10 is viewed in the front-rear direction. With this configuration, the vibration of the tool accessory TT can be absorbed in a more well-balanced manner by the elastic mechanisms 30.

Reference is made to FIG. 5. In the present embodiment, the plurality of elastic mechanisms 30 are arranged in parallel to each other so as to surround the side surface portion of the driving body 11 about the driving axis DX. According to this configuration, the dimension of the power tool 10 in the front-rear direction can be reduced as compared with a case where the elastic mechanisms 30 are provided at the rear-end portion of the driving body 11. Further, since the length of the elastic elements 31 in the front-rear direction can be increased while suppressing an increase in the dimension of the power tool 10 in the front-rear direction, an appropriate elastic force can be easily generated in the elastic elements 31.

In the present embodiment, the four elastic mechanisms 30 are arranged at the four corner portions (upper, lower, left, and right) around the motor accommodation portion 23. With this configuration, the space around the motor accommodation portion 23 in the rear-end side housing 16 can be effectively utilized, so that the power tool 10 can be further downsized.

### 1-4-4. Summary of Elastic Mechanism for Forming Vibration-Isolating Housing

As described above, in the power tool 10 according to the present embodiment, internal components such as electrical components can be easily assembled into the driving body housing 15 while the split outer wall members 16a, 16b constituting the rear-end side housing 16 are in a divided state. Further, when the rear-end side housing 16 is formed by connecting the split outer wall members 16a, 16b in the dividing direction, the rear-end portions of the elastic mechanisms 30 can be easily engaged with and fixed to the engagement portions 33 on the inner wall surfaces of the split outer wall members 16a, 16b. Accordingly, the rear-end side housing 16 can be easily configured as a vibration-isolating housing.

### 1-5. Cooling Air Passage

### 1-5-1. Configuration of Cooling Air Passage

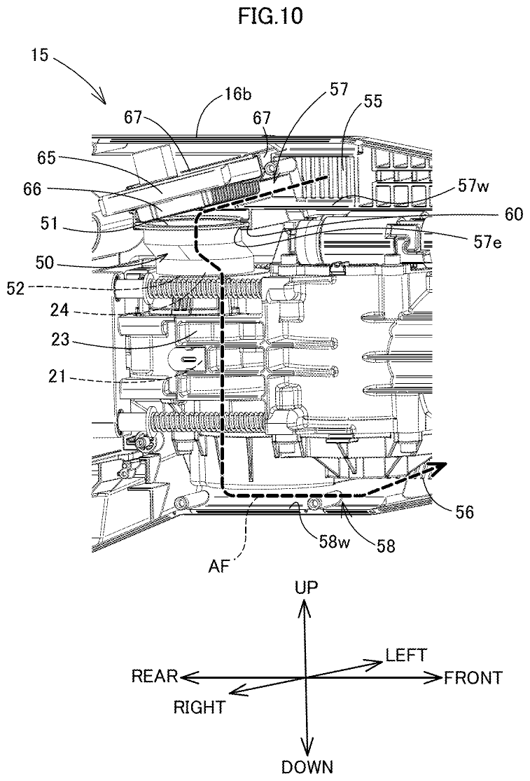

Reference is made to FIG. 10. FIG. 10 illustrates a state in which the internal structure of a portion of the power tool 10 is exposed at a location where the cooling air passage is formed, by removing the first split outer wall member 16a on the near side. In FIG. 10, the flow of the cooling air is indicated by a broken line arrow AF.

An inlet 55 for taking outside air into the power tool 10 is formed in each of the split outer wall members 16a, 16b (hereinafter simply referred to as “outer wall members 16a, 16b”) of the driving body housing 15. The inlet 55 is formed in an upper end portion of the motor accommodation portion 23. An inlet-side passage wall 57w is provided inside the split outer wall members 16a, 16b and defines an inlet-side passage 57 through which air flows toward the motor accommodation portion 23.

Between the pair of the outer wall members 16a, 16b, a passage member 50 is arranged to connect a downstream end of the inlet-side passage 57 and the motor accommodation portion 23. The configuration of the passage member 50 will be described later. Further, the control unit 65 is arranged in the inlet-side passage 57. The arrangement of the control unit 65 in the inlet-side passage 57 will also be described later.

An outlet-side passage wall 58w is provided on the outer wall members 16a, 16b and defines an outlet-side passage 58 through which air, introduced into the driving body housing 15 via the inlet-side passage 57, is discharged to the outside. In the present embodiment, the outlet-side passage 58 is arranged on the opposite side of the inlet-side passage 57 across the motor accommodation portion 23. An outlet 56 is formed in the outer wall members 16a, 16b and communicates with the outlet-side passage 58.

In the power tool 10 of the present embodiment, a cooling air passage indicated by broken line arrows AF is formed within the driving body housing 15 by the inlet-side passage 57, the passage member 50, and the outlet-side passage 58. Air introduced into the inlet-side passage 57 from the inlet 55 flows to the motor accommodation portion 23 through the passage member 50, and in the motor accommodation portion 23, cools the motor 21 by heat exchange with the motor 21. The air after the heat exchange flows from the motor accommodation portion 23 to the outlet-side passage 58 and is discharged from the outlet-side passage 58 to the outside of the driving body housing 15 through the outlet 56. In the present embodiment, the outlet 56 is provided on the front-end of the motor accommodation portion 23 and the transmission mechanism 25. Accordingly, the cooling air that has cooled components of the driving body 11 located on the front-end side of the motor accommodation portion 23, such as at least a portion of the striking mechanism 43, can be discharged from the outlet.

### 1-5-2. Configuration of Passage Member

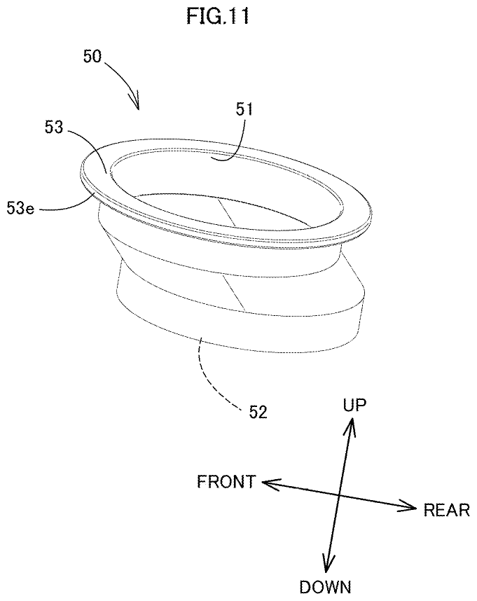

Reference is made to FIG. 11. FIG. 11 illustrates an example of the passage member 50. In FIG. 11, arrows indicating the front-rear direction and the up-down direction are shown with reference to the posture of the passage member 50 when installed in the driving body housing 15. The passage member 50 is configured as a flexible tubular member. The passage member 50 has a first opening 51 and a second opening 52 at respective ends thereof.

As shown in FIG. 10, the first opening 51 of the passage member 50 is open in direction intersecting the front-rear direction so as to be connected to an outlet opening 57e of the inlet-side passage 57 in said direction. In the present embodiment, the outlet opening 57e of the inlet-side passage 57 is open in the up-down direction. The first opening 51 of the passage member 50 is airtightly connected to the outlet opening 57e.

On the other hand, the second opening 52 of the passage member 50 is open in direction intersecting the front-rear direction so as to be connected to the communication port 24, which communicates with the inside of the motor accommodation portion 23, in said direction. As shown in FIGS. 2 and 5, the communication port 24 of the motor accommodation portion 23 is open in the up-down direction. As shown in FIG. 10, the second opening 52 of the passage member 50 is airtightly connected to the communication port 24 of the motor accommodation portion 23. The second opening 52 of the passage member 50 is fixedly fitted into the communication port 24 of the motor accommodation portion 23.

In the power tool 10, the outlet opening 57e of the inlet-side passage 57 and the communication port 24 of the motor accommodation portion 23 are connected via an airtight passage formed by the passage member 50. This allows air in the inlet-side passage 57 to be efficiently delivered into the motor accommodation portion 23 while suppressing the occurrence of air leakage. Consequently, the cooling efficiency of the motor 21 by the cooling air can be enhanced.

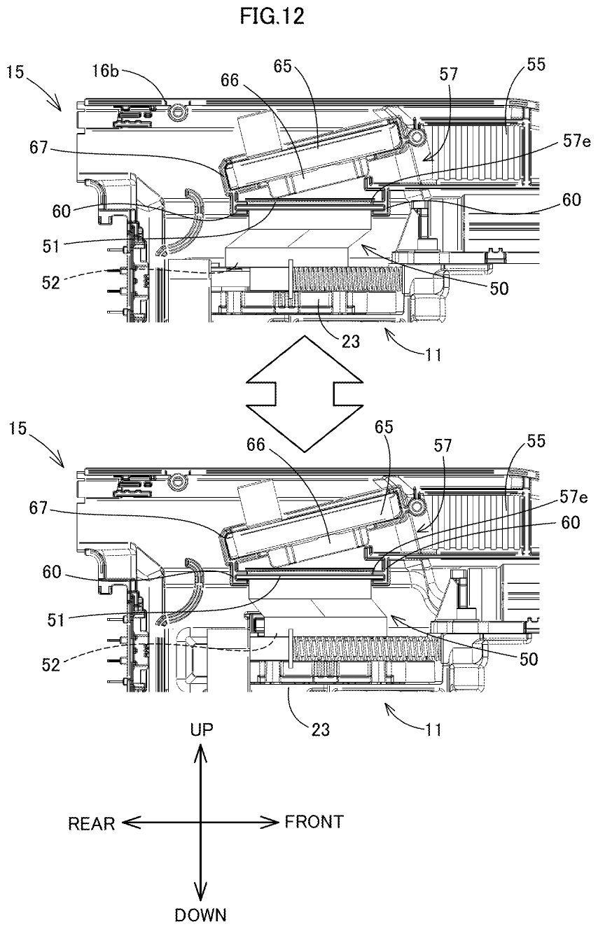

The upper section of FIG. 12 illustrates a state in which the driving body housing 15 is displaced to the front-end limit position relative to the driving body 11. On the other hand, the lower section of FIG. 12 illustrates a state in which the driving body housing 15 is displaced to the rear-end limit position relative to the driving body 11.

As described above, in the power tool 10, the driving body 11 is connected to the driving body housing 15 so as to be movable in the front-rear direction while receiving elastic force, thereby constituting a vibration-isolating housing structure. During operation of the power tool 10, as illustrated in FIG. 12, the driving body 11 and the driving body housing 15 move relative to each other in the front-rear direction, which causes the position of the motor accommodation portion 23 to be displaced in the front-rear direction within the driving body housing 15. Consequently, during operation of the power tool 10, the outlet opening 57e of the inlet-side passage 57 and the communication port 24 of the motor accommodation portion 23 are displaced relative to each other in the front-rear direction.

The passage member 50 is flexible and can flexibly deform so as to allow the first opening 51 and the second opening 52 to be displaced relative to each other in the front-rear direction. Therefore, even when the driving body 11 is displaced relative to the driving body housing 15 and the positional relationship between the outlet opening 57e of the inlet-side passage 57 and the communication port 24 of the motor accommodation portion 23 changes in the front-rear direction, the passage member 50 can flexibly deform to follow the change. Thus, even when vibration occurs in the power tool 10, the passage member 50 can maintain its connected state to the inlet-side passage 57 and the motor accommodation portion 23, thereby maintaining the supply route of the cooling air to the motor accommodation portion 23.

Further, as described above, the first opening 51 and the second opening 52 of the passage member 50 are connected to the outlet opening 57e of the inlet-side passage 57 and the communication port 24 of the motor accommodation portion 23, respectively, in a direction intersecting the front-rear direction. According to this configuration, the opening diameters of the first opening 51 and the second opening 52 can be increased. Thus, by increasing the opening diameters of the first opening 51 and the second opening 52, the airflow volume of the cooling air can be increased, and the cooling efficiency by the cooling air can be enhanced. Further, the first opening 51 and the second opening 52 of the passage member 50 are less likely to become detached from the outlet opening 57e of the inlet-side passage 57 and the communication port 24 of the motor accommodation portion 23 even when vibration in the front-rear direction occurs. Thus, the cooling air passage is suppressed from being affected by vibration during operation of the power tool 10.

In the present embodiment, the opening direction of the first opening 51 of the passage member 50 and the opening direction of the second opening 52 are parallel to each other, and the connection direction of the first opening 51 with respect to the outlet opening 57e and the connection direction of the second opening 52 with respect to the communication port 24 are parallel to each other. According to this configuration, when the driving body 11 is displaced relative to the driving body housing 15 in the front-rear direction, the deformation of the passage member 50 can be suppressed from becoming unbalanced between the first opening 51 side and the second opening 52 side. Thus, the flexing deformation of the passage member 50 during operation of the power tool 10 can be facilitated, and the influence of vibration on the cooling air passage during operation can be further reduced.

As shown in FIG. 11, the passage member 50 includes an opening member 53 as a skeleton member at the first opening 51. The opening member 53 has an annular shape and forms a peripheral edge portion of the first opening 51. The opening member 53 has sufficient rigidity to maintain the opening shape of the first opening 51. According to this configuration, the opening shape of the first opening 51 is retained even before the passage member 50 is assembled to the power tool 10, so that assembly of the passage member 50 to the driving body housing 15 can be facilitated. Further, because deformation of the first opening 51 can be suppressed even after assembly, the first opening 51 is suppressed from being closed by deformation of the passage member 50 due to the occurrence of vibration.

As shown in FIG. 11, the opening member 53 of the passage member 50 has a flange portion 53e that surrounds the first opening 51. The flange portion 53e is a portion that extends radially outward from the first opening 51.

As shown in FIGS. 2 and 10, the first opening 51 of the passage member 50 is connected to the outlet opening 57e of the inlet-side passage 57 by fitting the flange portion 53e into a passage fitting portion 60 provided on the inner wall surfaces of the outer wall members 16a, 16b. According to this configuration, assembly of the passage member 50 to the driving body housing 15 can be more easily facilitated by fitting the flange portion 53e into the passage fitting portion 60. Further, by fitting the flange portion 53e into the passage fitting portion 60, the fixability of the passage member 50 to the outlet opening 57e of the inlet-side passage 57 can be enhanced. Thus, disconnection of the passage member 50 from the driving body housing 15 due to vibration during operation can be suppressed.

As shown in FIG. 12, while the driving body housing 15 is moved in the front-rear direction relative to the driving body 11, the first opening 51 and the second opening 52 of the passage member 50 are configured to be kept overlapping each other in a direction orthogonal to the front-rear direction. In the present embodiment, the first opening 51 and the second opening 52 are kept overlapping each other in the up-down direction. According to this configuration, the passage length of the passage member 50 can be kept short, so that reduction in the cooling efficiency of the cooling air due to deformation of the passage member 50 can be suppressed. Further, because the range of deformation of the passage member 50 is compactly arranged, the deformation of the passage member 50 during operation of the power tool 10 can be further facilitated.

### 1-5-3. Arrangement of Control unit in Inlet-Side Passage

Reference is made to FIG. 10. In the power tool 10, the control unit 65 is arranged between the inlet 55 and the first opening 51 of the passage member 50 in the inlet-side passage 57. According to this configuration, the control unit 65 can be cooled together with the motor 21 in the motor accommodation portion 23 by the cooling air in the inlet-side passage 57. Thus, the cooling efficiency of the internal components in the power tool 10 can be further enhanced.

As shown in FIGS. 3 and 10, in the power tool 10, the control unit 65 is arranged so as to face the outlet opening 57e. According to this configuration, the control unit 65 can receive the cooling air over a wide area. Thus, the cooling efficiency of the control unit 65 by the cooling air can be further enhanced.

Further, as shown in FIGS. 3 and 10, the control unit 65 may be arranged obliquely with respect to the opening direction of the outlet opening 57e such that one substrate surface of the control unit 65 faces toward the outlet opening 57e and the inlet 55 located on the upstream side of the inlet-side passage 57. According to this configuration, the control unit 65 can be cooled by the cooling air while the substrate surface functions as a flow path wall to smoothly guide the cooling air toward the outlet opening 57e. Consequently, the cooling efficiency by the cooling air can be further enhanced.

Further, tall electronic components, such as a cylindrical capacitor, can be mounted on an upper substrate surface of the control unit 65 (on the side opposite to the outlet opening 57e) in a region that slopes obliquely downward toward the outlet opening 57e. According to this configuration, formation of dead space in the internal space of the power tool 10 can be suppressed, allowing the internal space to be efficiently utilized and the power tool 10 to be reduced in size.

A fin 66 is provided on the substrate surface of the control unit 65 that faces toward the outlet opening 57e. The fin 66 includes a plurality of wall portions arranged in parallel along the flow direction of the cooling air on the substrate surface. According to this configuration, by provision of the fin 66, the flow of the cooling air in the inlet-side passage 57 can be further facilitated while the cooling efficiency of the control unit 65 by the cooling air is enhanced. Thus, the cooling efficiency of the cooling air can be further enhanced.

As shown in FIGS. 2 and 3, the control unit 65 can be installed by being fitted into a substrate holding portion 67 provided on the inner wall surface of each of the split outer wall members 16a, 16b, in the dividing direction. According to this configuration, when the split outer wall members 16a, 16b are connected in the dividing direction to form the rear-end side housing 16, the assembly of the control unit 65 can be facilitated.

### 1-5-4. Summary of Cooling Air Passage

As described above, according to the configuration of the cooling air passage in the power tool 10 of the present embodiment, the cooling air can be efficiently delivered to the motor accommodation portion 23 through the passage member 50, and the cooling efficiency of the motor 21 can be enhanced. Further, because the influence of vibration during operation is suppressed by the flexibility of the passage member 50 and the connection manner of the passage member 50, a state in which the cooling air is efficiently supplied can be maintained.

### 1-6. Lighting Portion

Reference is made to FIGS. 1 and 3. As described above, the power tool 10 includes the lighting portion 70 having the light-emitting element 71 that emits light toward a workpiece. According to the power tool 10, since the workpiece can be irradiated with the light as illumination light emitted from the light-emitting element 71, visibility during operation for a user can be enhanced even in a working environment with low ambient light.

As shown in FIG. 1, in the power tool 10, an operation switch portion 80 to be operated by the user to control electric power is provided on the upper end side in the up-down direction. In the present embodiment, the operation switch portion 80 is provided on the upper connecting end portion 18a among the connecting end portions 18a and 18b that connect the grip portion 18 and the rear-end side housing 16.

A user of the power tool 10 can switch a power supply state in the power tool 10 by sliding an operating member of the operation switch portion 80 in the front-rear direction. The user can switch on and off the drive of the tool accessory TT by operating the operation switch portion 80. The light-emitting element 71 of the lighting portion 70 is electrically connected to the operation switch portion 80, so that on/off of light emission of the light-emitting element 71 can also be switched by the operation switch portion 80. In the present embodiment, the light-emitting element 71 is configured to automatically emit light in conjunction with the drive of the tool accessory TT when the drive of the tool accessory TT is switched on by the operation switch portion 80.

In the power tool 10, the light-emitting element 71 of the lighting portion 70 is provided on the same side as the operation switch portion 80 in the up-down direction. According to this configuration, the light-emitting element 71 and the operation switch portion 80 easily fall within the field of view of the user during operation. Thus, the visibility of the light-emitting element 71 and the operation switch portion 80 is improved, so that the workability during operation with the power tool 10 can be further enhanced. Further, since the wiring distance between the light-emitting element 71 and the operation switch portion 80 can be shortened, the power efficiency of the lighting portion 70 can be enhanced.

Referring to FIG. 1, as described above, the light-emitting element 71 is provided on an outer wall surface 72 that constitutes a step on the outside of the power tool 10 and faces forward in the front-rear direction. According to this configuration, a workpiece can be easily illuminated with the light from the light-emitting element 71. Thus, the workability during operation with the power tool 10 can be further enhanced.

Further, in the present embodiment, the light-emitting element 71 is provided on the outer wall surface 72 that constitutes a step on the outermost position in the up-down direction. According to this configuration, the light-emitting element 71 can illuminate the workpiece from a position spaced apart in the up-down direction from the driving shaft portion 13. Thus, interference of the illumination area of the light-emitting element 71 with the driving shaft portion 13 is suppressed, and the illumination area can be further expanded.

Reference is made to FIG. 3. In the power tool 10, the light-emitting element 7 is provided forward of the transmission mechanism 25. The light-emitting element 71 is provided above the striking mechanism 43. According to this configuration, since the light-emitting element 71 is arranged closer to a workpiece, the workpiece can be more easily illuminated by the light-emitting element 71. Thus, the workability during operation with the power tool 10 can be further enhanced.

In the power tool 10, the lighting portion 70 including the light-emitting element 71 is provided on the driving body housing 15 that functions as a vibration-isolating housing. According to this configuration, since transmission of vibration from the driving body 11 to the light-emitting element 71 can be suppressed, shaking of the illumination area of the light-emitting element 71 can be suppressed, and the workpiece can be stably illuminated. Thus, the workability during operation with the power tool 10 can be further enhanced. Further, components of the lighting portion 70 can be suppressed from being damaged or deteriorated by receiving a load due to vibration of the driving body 11.

As shown in FIG. 3, in the present embodiment, the outer wall surface 72 on which the light-emitting element 71 is provided constitutes the forwardmost end surface of the driving body housing 15. According to this configuration, the light-emitting element 71 is arranged at a position closest to the workpiece within the driving body housing 15, which can suppress the influence of vibration from the driving body 11. Thus, the workpiece can be more reliably irradiated with light, and can be stably illuminated in a state where the influence of vibration is suppressed during operation.

In the power tool 10, the light-emitting element 71 is provided in the rear-end side housing 16 among the front-side housing 17 and the rear-end side housing 16. In the power tool 10, an electrical system that is electrically connected to the operation switch portion 80 and the motor 21 is housed in the rear-end side housing 16, so that main components of the electrical system of the power tool 10 are collected together in the rear-end side housing 16. Thus, by providing the lighting portion 70 in the rear-end side housing 16, the electrical wiring of the lighting portion 70 is shortened, so that the power efficiency of the lighting portion 70 is enhanced. Further, since the lighting portion 70 can be assembled together with other electrical components installed in the rear-end side housing 16, the assemblability of the lighting portion 70 to the power tool 10 can be enhanced.

In the power tool 10, as described above, the battery mounting portion 19 is provided on the rear-end side housing 16. The battery BT mounted on the battery mounting portion 19 corresponds to a power supply that supplies power to the motor 21 and the lighting portion 70. Therefore, by providing the lighting portion 70 on the rear-end side housing 16, the wiring distance between the battery BT and the lighting portion 70 can be shortened, so that the power efficiency of the lighting portion 70 can be further enhanced.

As shown in FIG. 3, in the power tool 10, the control unit 65 is provided on the same side as the operation switch portion 80 and the light-emitting element 71 in the up-down direction. According to this configuration, the wiring distance among the operation switch portion 80, the light-emitting element 71, and the control unit 65 can be shortened. Thus, the power efficiency of the power tool 10 can be further enhanced.

Reference is made to FIG. 2. In the power tool 10, the driving body housing 15 is formed of a plurality of members, and the lighting portion 70 and the control unit 65 are held by the same member among the plurality of members. According to this configuration, since the lighting portion 70 and the control unit 65 can be held by the same member in an assembly process of the power tool 10, the assemblability of the power tool 10 can be enhanced. In the present embodiment, the members forming the driving body housing 15 include a pair of split outer wall members 16a, 16b that form the rear-end side housing 16. With the rear-end side housing 16 formed by the split outer wall members 16a, 16b, assembly of internal components to the inside of the rear-end side housing 16 is facilitated as described above.

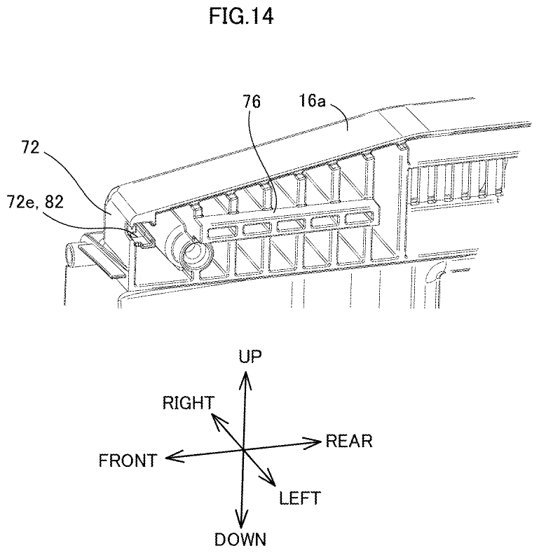

In the present embodiment, the same member that holds the lighting portion 70 and the control unit 65 is the first split outer wall member 16a of the pair of split outer wall members 16a, 16b. The light-emitting element 71 of the lighting portion 70 is fitted and held in an element holding portion 82 that constitutes a part of an outer-wall surface fitting portion 72e provided on the first split outer wall member 16a. The element holding portion 82 is also shown in FIG. 14. The control unit 65 is held by a substrate holding portion 83 provided on the first split outer wall member 16a. According to this configuration, the second split outer wall member 16b can be fitted and connected to the first split outer wall member 16a in a state where the light-emitting element 71 and the control unit 65 are held by the first split outer wall member 16a. Thus, the lighting portion 70 and the control unit 65 can be easily assembled to the rear-end side housing 16, so that the assemblability of the power tool 10 is further enhanced.

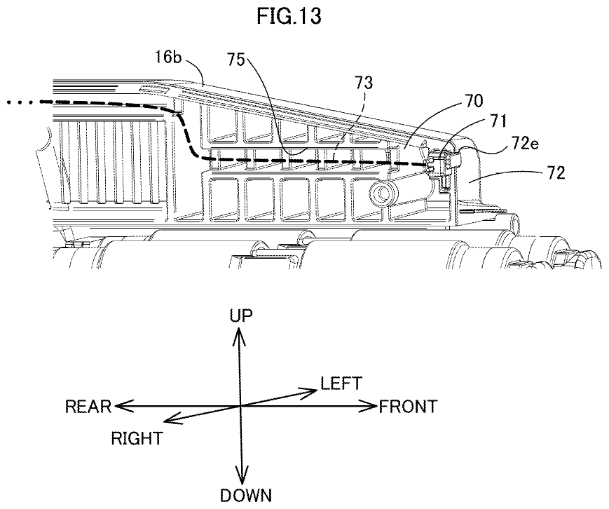

Reference is made to FIGS. 13 and 14 in addition to FIG. 2. FIG. 13 illustrates the vicinity of a position where the light-emitting element 71 is provided on the second split outer wall member 16b that constitutes the left side surface of the power tool 10. FIG. 14 illustrates the vicinity of a position where the light-emitting element 71 to be provided on the first split outer wall member 16a that constitutes the right side surface of the power tool 10.

The light-emitting element 71 is held between the pair of split outer wall members 16a, 16b by being fitted in an outer wall surface fitting portion 72e in a dividing direction of the split outer wall members 16a, 16b. The outer wall surface fitting portion 72e is formed by a groove provided in a peripheral edge portion of a through hole of the outer wall surface 72. FIG. 13 illustrates a state where the light-emitting element 71 is fitted in the outer wall surface fitting portion 72e. According to this configuration, the light-emitting element 71 can be easily assembled while the pair of the split outer wall members 16a, 16b are separated from each other. Thus, the assemblability of the light-emitting element 71 to the rear-end side housing 16 can be further enhanced.

Reference is made to FIGS. 13 and 14. A groove-like wiring portion 75 and a ridge portion 76 are provided on inner wall surfaces of the split outer wall members 16a, 16b and are fitted to each other when the rear-end side housing 16 is formed. In the present embodiment, as shown in FIG. 13, the groove-like wiring portion 75 is provided on the second split outer wall member 16b that constitutes the left side surface of the power tool 10, and as shown in FIG. 14, the ridge portion 76 is provided on the first split outer wall member 16a that constitutes the right side surface of the power tool 10.

As shown in FIG. 13, the groove-like wiring portion 75 is formed by a groove that is recessed in the dividing direction on the inner wall surface of the second split outer wall member 16b and extends in the front-rear direction from the installation position of the light-emitting element 71. As shown in FIG. 14, the ridge portion 76 is formed by a protrusion that extends in the front-rear direction on the inner wall surface of the first split outer wall member 16a.

In FIG. 13, for convenience, an electrical wiring 73 connected to the light-emitting element 71 is shown by a broken line. As shown in FIG. 13, the electrical wiring 73 of the light-emitting element 71 is disposed in the groove-like wiring portion 75. When the rear-end side housing 16 is formed, the ridge portion 76 is fitted into the groove-like wiring portion 75, so that the electrical wiring 73 is disposed between the groove-like wiring portion 75 and the ridge portion 76.

According to this configuration, by fitting the ridge portion 76 into the groove-like wiring portion 75, the rigidity of a portion where the electrical wiring 73 is disposed can be increased. Further, since the electrical wiring 73 can be surrounded by the groove-like wiring portion 75 and the ridge portion 76, the protection of the electrical wiring 73 can be enhanced. In addition, since the electrical wiring 73 can be pushed into the groove-like wiring portion 75 by the ridge portion 76, displacement of the electrical wiring 73 can be suppressed. During assembly of the light-emitting element 71 to the rear-end side housing 16, the electrical wiring 73 can be appropriately disposed by being accommodated in the groove-like wiring portion 75. Thus, the assemblability of the electrical wiring 73 of the lighting portion 70 to the power tool 10 can be further enhanced.

As described above, since the power tool 10 of the present embodiment is provided with the lighting portion 70, the visibility of a workpiece for a user can be enhanced even in a working environment with little ambient light. Thus, the workability of the power tool 10 can be improved. Further, according to the power tool 10 of the present embodiment, the power efficiency of the power tool 10 and the assemblability of the lighting portion 70 to the power tool 10 are further enhanced by the arrangement position and the wiring configuration of the lighting portion 70.

### 2. OTHER EMBODIMENTS

The technology of the present disclosure is not limited to the configurations of the above-described embodiments. For example, the following modifications can be made. Similar to the configurations of the above-described embodiments, the configurations of the following embodiments are also contemplated as embodiments for implementing the teachings of the present disclosure.

In the above-described embodiment, the elastic element 31 of the elastic mechanism 30 may be formed by an elastically deformable member other than a coil spring. The elastic element 31 may be arranged separately from the guide member 34 without being provided on the outer periphery of the guide member 34. The rear-end portion of the elastic mechanism 30 may be formed by another engaged member with which the engagement portions 33 can engage, instead of being formed by the tubular member 35. In the above-described embodiment, the guide member 34 may be formed by, for example, a linear member instead of the shaft-like member. In the above-described embodiment, the power tool 10 may be provided with five or more elastic mechanisms 30, or it may be provided with three or fewer elastic mechanisms 30.

### 3. OTHER ASPECTS

The teachings of the present disclosure described in the above embodiment can be implemented, for example, as other Aspects A, B described below. The configurations of the power tools according to Aspects A, B will be described after their respective background arts.

### 3-1. Aspect A

### 3-1-1. Background Art

A power tool having a hammer mechanism is used, for example, for chipping operations, and configured to strike a workpiece by reciprocating a tool accessory mounted to a front end thereof, in the front-rear direction via a motor. In such a power tool, a housing to which a grip portion to be held by a user is connected may be configured as a vibration-isolating housing that restrains or reduces transmission of vibration of the tool accessory to the grip portion during operation of the power tool by utilizing elastic deformation of an elastic element arranged in the housing. Further, a cooling air passage may be formed inside the housing to introduce outside air toward an internal heating element, such as a motor, perform heat exchange with the heating element, and then discharge the air.

In order to absorb vibration during operation, the vibration-isolating housing of the power tool is normally connected to an internal body (hereinafter also referred to as a “driving body”), which includes a driving mechanism for driving the tool accessory, in a displaceable manner via an elastic element. Therefore, it is preferable that the cooling air passage inside the vibration-isolating housing is configured such that supply of cooling air to the driving body is maintained even if the driving body is displaced relative to the vibration-isolating housing due to vibration during operation.

For example, Patent Document 2 (European Patent No. 1637288) discloses a power tool in which a cooling air passage is formed by a piping member that is extensible and contractible in a driving direction of the tool accessory, such that the passage deforms so as to follow the displacement of the driving body relative to the vibration-isolating housing.

Further, Patent Document 3 (European Patent Application Publication No. 4282595) discloses a power tool in which one end of a piping member defining a cooling air passage is fixed to the vibration-isolating housing, while the other end thereof is not fixed to the driving body, so as to allow displacement of the driving body relative to the vibration-isolating housing.

In the power tool of Patent Document 2, however, the extensible and contractible piping member is arranged along the driving direction at the upper end portion of the tool accessory, making it difficult to increase the opening diameter of its open end. A small opening diameter restricts the airflow volume, which may reduce cooling efficiency. Conversely, any attempt to increase the opening diameter of the piping member may result in an undesirable increase in the overall size of the power tool.

In the power tool of Patent Document 3, airtightness at the end portion of the piping member that is not fixed to the driving body may be compromised, potentially leading to reduced cooling efficiency. Furthermore, the non-fixed end of the piping member may be subject to wear or damage due to sliding contact with the vibrating driving body. Thus, in power tools, there remains room for improvement regarding the configuration of cooling air passages within vibration-isolating housings.

It is accordingly an object of Aspect A of the present disclosure to provide a technique for forming a cooling air passage inside a power tool that minimizes the influence of vibration during operation while maintaining high cooling efficiency.

### 3-1-2. Configuration of Aspect A

### Aspect A1:

Aspect A1 is provided as a power tool having a driving mechanism. The power tool of this Aspect includes a driving body, a driving body housing, and a passage member. The driving body includes a tool mounting portion that is provided on a front end and to which a tool accessory that is driven in a front-rear direction and strikes a workpiece is mounted, and a motor accommodation portion that is arranged rearward of the tool mounting portion and houses a motor that drives the tool accessory. The driving body housing is arranged rearward of the tool mounting portion and houses at least the motor accommodation portion of the driving body. The driving body housing is connected to the driving body so as to be movable in the front-rear direction while receiving the elastic force in the front-rear direction. The driving body housing has an outer wall member having an inlet for taking in outside air, and an inlet-side passage is formed inside the driving body housing and forms a flow of air from the inlet to the motor accommodation portion. The passage member is a flexible, tubular member that is arranged inside the driving body housing. The passage member has a first opening that is connected to an outlet opening of the inlet-side passage in a direction crossing the front-rear direction, and a second opening that is connected in a direction crossing the front-rear direction to a communication port that communicates with the inside of the motor accommodation portion. The passage member flexibly deforms such that the first and second openings are displaced relative to each other in the front-rear direction when the driving body and the driving body housing move relative to each other in the front-rear direction.

In the power tool according to Aspect A1, the inlet-side passage for cooling air provided inside the driving body housing, which functions as a vibration-isolating housing, is connected to the motor accommodation portion of the driving body via the passage member that is flexibly deformable in the front-rear direction. Consequently, air taken in from the inlet is efficiently delivered as cooling air to the motor accommodation portion through the passage member. Furthermore, even when the driving body is displaced relative to the driving body housing in the front-rear direction, the passage member deforms to follow the displacement, thereby maintaining the continuity of the cooling air supply path even during vibration. In addition, the openings at both ends of the passage member are connected to the outlet opening of the inlet-side passage and the communication port of the driving body in a direction crossing the front-rear direction. Consequently, the opening diameters of the first and second openings of the passage member can be increased, thereby increasing the cooling airflow volume and enhancing the cooling efficiency.

### Aspect A2:

In the power tool according to Aspect A1, the connection direction of the first opening with respect to the outlet opening may be parallel to the connection direction of the second opening with respect to the communication port.

In the power tool according to Aspect A2, it is possible to suppress the deformation of the passage member from becoming unbalanced between the first opening side and the second opening side when the driving body is displaced relative to the driving body housing in the front-rear direction. Consequently, flexural deformation of the passage member during operation of the power tool can be smoothened, and the influence of vibration on the passage of the cooling air during operation of the power tool can be further reduced.

### Aspect A3:

In the power tool according to Aspect A1 or A2, the passage member may include an annular opening member that forms a peripheral edge portion of the first opening and has sufficient rigidity to maintain an opening shape of the first opening.

In the power tool according to Aspect A3, since the opening shape of the first opening is maintained even before the passage member is assembled to the power tool, assembly of the passage member to the driving body housing can be facilitated. Furthermore, because deformation of the first opening is suppressed even after assembly, the first opening is prevented from being obstructed by deformation of the passage member caused by vibration during operation.

### Aspect A4:

In the power tool according to any one of Aspects A1, A2 and A3, the opening member may include a flange that surrounds the first opening, and the driving body housing may be provided with a passage fitting portion into which the flange is fitted.

In the power tool according to Aspect A4, fitting the flange into the passage fitting portion facilitates the assembly of the passage member to the driving body housing. Furthermore, the engagement of the flange with the passage fitting portion enhances the fixity of the passage member relative to the outlet opening. Consequently, the passage member can be further suppressed from being disconnected from the driving body housing due to vibration during operation.

### Aspect A5:

In the power tool according to any one of Aspects A1, A2, A3 and A4, the first and second openings may be configured to maintain an overlapped state with each other in a direction orthogonal to the front-rear direction while the driving body housing moves relative to the driving body in the front-rear direction.

In the power tool according to Aspect A5, since the path length of the passage member can be kept short, a reduction in the cooling efficiency of the cooling air due to deformation of the passage member can be suppressed.

### Aspect A6:

In the power tool according to any one of Aspects A1, A2, A3, A4 and A5, the power tool may include a control unit configured to control the power tool, wherein the control unit is arranged in the inlet-side passage between the inlet and the first opening.

In the power tool according to Aspect A6, the cooling air can cool both the control unit and the motor in the motor accommodation portion. Consequently, the cooling efficiency of the internal components within the power tool can be further enhanced.

### Aspect A7:

In the power tool according to any one of Aspects A1, A2, A3, A4, A5 and A6, the control unit may be arranged so as to face the outlet opening.

In the power tool according to Aspect A7, the control unit can receive the cooling air over a wide area, so that the cooling efficiency of the control unit by the cooling air is further enhanced.

### Aspect A8:

In the power tool according to any one of Aspects A1, A2, A3, A4, A5, A6 and A7, the control unit may include a substrate surface that is arranged obliquely relative to an opening direction of the outlet opening so as to face an upstream side of the inlet-side passage.

In the power tool according to Aspect A8, the substrate surface of the control unit functions as a flow path wall while being cooled by the cooling air, thereby smoothly guiding the cooling air toward the outlet opening. Consequently, the cooling efficiency is further improved.

### Aspect A9:

In the power tool according to any one of Aspects A1, A2, A3, A4, A5, A6, A7 and A8, the control unit may include a fin that is arranged along a flowing direction of air in the inlet-side passage.

In the power tool according to Aspect A9, the fins of the control unit smoothen the flow of cooling air within the inlet-side passage while enhancing the cooling efficiency of the control unit. Consequently, the cooling efficiency of the cooling air can be further enhanced.

### Aspect A10:

In the power tool according to any one of Aspects A1, A2, A3, A4, A5, A6, A7, A8 and A9, an outlet-side passage through which air led into the driving body housing through the inlet-side passage is discharged to the outside may be provided inside the driving body housing, and an outlet may be formed in front of the motor accommodation portion in an outer wall member of the driving body housing and communicates with the outlet-side passage.

In the power tool according to Aspect A10, the cooling air is heat-exchanged with components in the driving body such as the striking mechanism arranged in front of the motor, and smoothly discharged through the outlet.

### Aspect A11:

In the power tool according to any one of Aspects A1, A2, A3, A4, A5, A6, A7, A8, A9 and A10, a grip portion may be provided on a rear end of the driving body housing and configured to be held by a user. The tool mounting portion, the motor accommodation portion and the grip portion may be arranged to overlap each other when viewed in the front-rear direction. The driving body housing may have a battery mounting portion to which a battery for supplying power to the motor is mounted, between the grip portion and the motor accommodation portion.

According to Aspect A11, the hand-held, rechargeable power tool can be configured with a compact design.

### 3-1-3. Other Configuration Examples of Aspect A

The configurations of the above-described embodiment corresponding to those of Aspect A may be modified or changed, for example, as follows. As with the configurations of the above-described embodiment, the following configurations are also regarded as embodiments of Aspect A.

The configuration of the cooling air passage in the above-described embodiment may be applied to a power tool that is different in configuration from the power tool 10 of the above-described embodiment. The configuration of the cooling air passage in the above-described embodiment may be applied to a power tool, for example, in which a pair of columnar grip portions extend symmetrically to the left and right from the rear-end portion of the rear body. The configuration of the cooling air passage in the above-described embodiment may be applied to a power tool, for example, in which the motor is arranged offset below the driving axis DX. The configuration of the cooling air passage in the above-described embodiment may be applied to a power tool that is configured to be driven by power supply from an external power source through a power cord.

The passage member that forms the cooling air passage is not limited to the configuration of the passage member 50 described in the above embodiment. For example, the openings of the both ends of the passage member may be open in respective directions crossing each other. In the above-described embodiment, air of the inlet-side passage may be led into other than the motor accommodation portion of the driving body. The outlet-side passage may be configured such that the cooling air is heat-exchanged with component elements of the driving body other than the motor and is discharged. In the present embodiment, the control unit 65 may include component elements other than the substrate. Component elements other than the control substrate that forms the control unit 65 may be arranged in the cooling air passage.

### 3-2. Aspect B

### 3-2-1. Background Art

A power tool having a hammer mechanism is used, for example, for chipping operation, and configured to strike a workpiece by reciprocating a tool accessory, which is mounted to a front end thereof, in the front-rear direction driven by a motor. The power tool may be of a hand-held type in which a grip portion to be held by a user is provided on the rear end.

For example, patent document 4 (Japanese Unexamined Patent Application Publication No. 2015-182167) discloses an electric hammer as a representative example of a hand-held power tool having a hammer mechanism.

The power tool having a hammer mechanism is expected to be used in various working environments. Therefore, it is desirable to provide a power tool to be configured to exert functions corresponding to specific working environments so as to enhance the workability.

It is accordingly an object of Aspect B to provide a power tool that can enhance the workability.

### 3-2-2. Configuration of Aspect B

### Aspect B1:

Aspect B1 is provided as a power tool having a hammer mechanism. The power tool of this Aspect includes a tool mounting portion, a driving mechanism, a motor, a grip portion, an operation switch portion and a lighting portion. A tool accessory that is driven in a front-rear direction and strikes a workpiece is mounted to the tool mounting portion. The driving mechanism has a driving shaft portion extending in a shaft-like form in the front-rear direction from a rear end of the tool mounting portion, and transmits a driving force to the tool accessory via the driving shaft portion. The motor is arranged on a driving shaft that corresponds to a central axis of the driving shaft portion, in a rear portion of the driving mechanism. The motor generates the driving force that is transmitted to the driving mechanism. The grip portion is configured to be held by a user and has a columnar shape extending in an up-down direction orthogonal to the front-rear direction and crossing the driving shaft, rearward of the motor. The operation switch portion is provided in one end portion of the power tool in the up-down direction and configured to be operated by the user to control electric power. The lighting portion is electrically connected to the operation switch portion and arranged on the same side as the operation switch portion in the up-down direction to emit light toward the workpiece.

With the configuration of this Aspect, a hand-held power tool is provided in a compact configuration in which the tool accessory, the motor and the grip portion are arranged in alignment in the direction of the driving shaft. In the power tool of this Aspect, the lighting portion can emit light toward the workpiece. Accordingly, the visibility of the workpiece is improved, for example, even in a working environment with little environmental light, so that the workability in an operation using the power tool is improved. Furthermore, since the operation switch portion and the lighting portion are arranged on the same side in the up-down direction, the user's visibility of both the operation switch portion and the lighting portion is improved during an operation. Thus, the workability of operations using the power tool is further enhanced.

### Aspect B2:

In the power tool according to Aspect B1, the lighting portion may be arranged on an outer wall surface that faces forward in the front-rear direction.

According to the power tool of Aspect B2, the workpiece can be easily irradiated with light of the lighting portion. Thus, the workability of operations using the power tool is further enhanced.

### Aspect B3:

In the power tool according to Aspect B1 or B2, the driving mechanism may include a transmission mechanism that is arranged between the driving shaft portion and the motor and is configured to transmit the driving force of the motor to the driving shaft portion, and the lighting portion may be arranged in front of the transmission mechanism.

According to the power tool of Aspect B3, the lighting portion can be arranged closer to the workpiece, so that the workpiece can be more easily illuminated by the light portion. Thus, the workability in an operation using the power tool is further enhanced.

### Aspect B4:

In the power tool according to any one of Aspects B1, B2 and B3, a rotational axis of the motor may extend in the up-down direction parallel to the grip portion.

According to the power tool of Aspect B4, the motor is easily arranged within a region in the up-down direction in which the grip portion extends. Thus, the power tool is formed more compact in configuration.

### Aspect B5:

In the power tool according to any one of Aspects B1, B2, B3 and B4, the power tool may comprise a driving body and a driving body housing. The driving body includes the tool mounting portion on a front end, and the driving mechanism and a motor accommodation portion that houses the motor, rearward of the tool mounting portion. The driving body housing includes the grip portion, and is arranged rearward of the tool mounting portion and houses at least the motor accommodation portion. The driving body housing is connected to the driving body to move in the front-rear direction while receiving the elastic force in the front-rear direction. The lighting portion may be arranged on the driving body housing.

According to the power tool of Aspect B5, transmission of vibration from the driving body to the driving body housing during operation of the power tool is suppressed by the action of the elastic force, thereby allowing a user to hold the power tool more stably. Further, since transmission of vibration from the driving body to the lighting portion is suppressed, shaking of the light illumination area of the lighting portion is inhibited, and the workpiece can be illuminated stably. Thus, the workability of operations using the power tool is further enhanced. Furthermore, components of the lighting portion are inhibited from being damaged or deteriorated by loads caused by vibration of the driving body.

### Aspect B6:

In the power tool according to any one of Aspects B1, B2, B3, B4 and B5, the power tool may comprise a driving body housing and a control unit that controls the power tool. The driving body housing is formed of a plurality of members, and houses at least a rear portion of the driving mechanism and the motor, and the grip portion is connected to a rear end of the driving body housing. The lighting portion and the control unit may be held by the same members among the plurality of members.

According to the power tool of Aspect B6, the lighting portion and the control unit can be held by the same member among the members constituting the driving body housing. Consequently, since the driving body housing can be constructed while the lighting portion and the control unit are held by the same member, the ease of assembly of the power tool is improved.

### Aspect B7:

In the power tool according to any one of Aspects B1, B2, B3, B4, B5 and B6, the plurality of members may include a pair of split outer wall members that can be separated in a dividing direction orthogonal to the front-rear direction.

According to the power tool of Aspect B7, the driving body housing is formed a pair of split outer wall members, so that internal components can be easily assembled to the driving body housing.

### Aspect B8:

In the power tool according to any one of Aspects B1, B2, B3, B4, B5, B6 and B7, a groove-like wiring portion and a ridge portion may be provided on inner wall surfaces of the pair of split outer wall members and are configured to be fitted together when the rear-end side housing is formed, and an electrical wiring of the lighting portion may be disposed between the groove-like wiring portion and the ridge portion.

According to the power tool of Aspect B8, since the ridge portion is fitted into the groove-like wiring portion, the rigidity of a portion where the electrical wiring of the lighting portion is disposed can be increased. Further, since the electrical wiring can be surrounded by the groove-like wiring portion and the ridge portion, the protection of the electrical wiring is enhanced. Furthermore, since the electrical wiring can be pushed into the groove-like wiring portion by the ridge portion, displacement of the electrical wiring is suppressed. Additionally, the electrical wiring can be appropriately disposed by being accommodated in the groove-like wiring portion, so that the ease of assembly of the electrical wiring is further enhanced.

### Aspect B9:

In the power tool according to any one of Aspects B1, B2, B3, B4, B5, B6, B7 and B8, the rear-end side housing may have a battery mounting portion to which a battery for supplying power to the motor and the lighting portion is mounted.

According to the power tool of Aspect B9, the wiring distance between the battery and the lighting portion can be shortened, thereby further enhancing the power efficiency of the lighting portion.

### Aspect B10:

In the power tool according to any one of Aspects B1, B2, B3, B4, B5, B6, B7, B8 and B9, the power tool may comprise a control unit, and the control unit may be arranged on the same side as the operation switch portion and the lighting portion in the up-down direction.

According to the power tool of Aspect B10, the wiring distance between the operation switch portion, the lighting portion and the control unit can be shortened, thereby enhancing the power efficiency of the power tool.

### 3-2-3. Other Configuration Examples of Aspect B

The configurations of the above-described embodiment corresponding to those of Aspect B may be modified or changed, for example, as follows. As with the configurations of the above-described embodiment, the following configurations are also regarded as embodiments of Aspect B.

The location where the lighting portion is arranged is not limited to the location described in the above-described embodiment. For example, the lighting portion may be provided on a front-side housing, or the lighting portion may be provided on an inclined surface that faces forward. The lighting portion may be arranged on a side surface of the power tool. Further, the lighting portion may be applied to a power tool that does not have a vibration-isolating housing. In the above-described embodiment, the position of the lighting portion can be construed as the position of a light-emitting element. In the above-described embodiment, the rear-end side housing may be formed of a plurality of portions other than the pair of split outer wall members.

1. A power tool having a hammer mechanism, comprising:
a driving body, including a tool mounting portion on a front end and to which a tool accessory that is driven in a front-rear direction and strikes a workpiece is mounted, and a driving mechanism that includes a motor and drives the tool accessory, the driving mechanism being arranged rearward of the tool mounting portion;
a driving body housing, including: a rear-end side housing that is formed by a pair of split outer wall members that can be separated in a dividing direction orthogonal to the front-rear direction, and houses at least a rear-end portion of the driving body; and a grip portion that is provided on the rear-end portion to be held by a user, wherein the driving body housing is connected to the driving body to move in the front-rear direction relative to the driving body;
a guide member that guides movement of the driving body housing relative to the driving body in the front-rear direction, the guide member being fixed to the driving body along the front-rear direction within the driving body housing and connected to the driving body housing so as to allow the driving body housing to be movable in the front-rear direction;
an elastic mechanism that is arranged within the rear-end side housing and includes an elastic element that generates an elastic force in the front-rear direction by elastically deforming when the driving body moves in the front-rear direction relative to the driving body housing, and applies the elastic force to the driving body at one end portion of the elastic mechanism in the front-rear direction, while applying the elastic force to the driving body housing at the other end portion; and
an engagement portion that is provided on an inner wall surface of the split outer wall member and configured to be engaged with the other end portion of the elastic mechanism.

2. The power tool having a hammer mechanism according to claim 1, wherein:
the guide member is a shaft-like member; and
the elastic element is a coil spring that is arranged around an outer periphery of the guide member and configured to generate the elastic force by expanding and contracting in the front-rear direction.

3. The power tool having a hammer mechanism according to claim 2, wherein:
the elastic mechanism includes a tubular member, the tubular member having a bore through which the guide member is inserted, and being configured to move along the guide member in contact with an end of the elastic element;
the tubular member constitutes the other end of the elastic mechanism; and
the engagement portion is engaged with the tubular member of the elastic mechanism.

4. The power tool having a hammer mechanism according to claim 3, wherein an engaged portion of the tubular member that is engaged with the engagement portion has substantially the same length in the front-rear direction as the length of the engagement portion in the front-rear direction.

5. The power tool having a hammer mechanism according to claim 3, wherein the engagement portion defines a groove that has a substantially semicircular cross-sectional shape opening in the dividing direction and extends in the front-rear direction, and the engagement portion is configured to engage with the tubular member by receiving the tubular member within the groove in the dividing direction.

6. The power tool having a hammer mechanism according to claim 3, wherein the tubular member is arranged in the elastic mechanism while receiving the elastic force of the elastic element.

7. The power tool having a hammer mechanism according to claim 1, wherein:
the grip portion has a columnar structure extending in an up-down direction orthogonal to the front-rear direction and a left-right direction orthogonal to the front-rear direction, at a center of the power tool in the left-right direction; and
a plurality of the elastic mechanisms are provided on both sides of the grip portion in the left-right direction.

8. The power tool having a hammer mechanism according to claim 7, wherein:
at least four such elastic mechanisms are provided; and
at least two of the elastic mechanisms are arranged in the up-down direction on each of both sides of the grip portion in the left-right direction.

9. The power tool having a hammer mechanism according to claim 1, wherein:
the grip portion has a columnar structure extending in an up-down direction orthogonal to the front-rear direction and a left-right direction orthogonal to the front-rear direction; and
the tool accessory, the motor and the grip portion are arranged to overlap each other when viewed in the front-rear direction.

10. The power tool having a hammer mechanism according to claim 9, wherein a rotational axis of the motor extends in the up-down direction along with the grip portion.

11. The power tool having a hammer mechanism according to claim 1, wherein a battery mounting portion to which a battery for supplying power to the motor is mounted is provided on the driving body housing.

12. The power tool having a hammer mechanism according to claim 1, wherein:
the elastic mechanism includes a tubular member, the tubular member having a bore through which the guide member is inserted, and being configured to move along the guide member in contact with an end of the elastic element;
the tubular member constitutes the other end of the elastic mechanism; and
the engagement portion is engaged with the tubular member of the elastic mechanism.

13. The power tool having a hammer mechanism according to claim 4, wherein the engagement portion defines a groove that has a substantially semicircular cross-sectional shape opening in the dividing direction and extends in the front-rear direction, and the engagement portion is configured to engage with the tubular member by receiving the tubular member within the groove in the dividing direction.

14. The power tool having a hammer mechanism according to claim 4, wherein the tubular member is arranged in the elastic mechanism while receiving the elastic force of the elastic element.

15. The power tool having a hammer mechanism according to claim 5, wherein the tubular member is arranged in the elastic mechanism while receiving the elastic force of the elastic element.

16. The power tool having a hammer mechanism according to claim 2, wherein:
the grip portion has a columnar structure extending in an up-down direction orthogonal to the front-rear direction and a left-right direction orthogonal to the front-rear direction, at a center of the power tool in the left-right direction; and
a plurality of the elastic mechanisms are provided on both sides of the grip portion in the left-right direction.

17. The power tool having a hammer mechanism according to claim 3, wherein:
the grip portion has a columnar structure extending in an up-down direction orthogonal to the front-rear direction and a left-right direction orthogonal to the front-rear direction, at a center of the power tool in the left-right direction; and
a plurality of the elastic mechanisms are provided on both sides of the grip portion in the left-right direction.

18. The power tool having a hammer mechanism according to claim 4, wherein:
the grip portion has a columnar structure extending in an up-down direction orthogonal to the front-rear direction and a left-right direction orthogonal to the front-rear direction, at a center of the power tool in the left-right direction; and
a plurality of the elastic mechanisms are provided on both sides of the grip portion in the left-right direction.

19. The power tool having a hammer mechanism according to claim 5, wherein:
the grip portion has a columnar structure extending in an up-down direction orthogonal to the front-rear direction and a left-right direction orthogonal to the front-rear direction, at a center of the power tool in the left-right direction; and
a plurality of the elastic mechanisms are provided on both sides of the grip portion in the left-right direction.

20. The power tool having a hammer mechanism according to claim 6, wherein:
the grip portion has a columnar structure extending in an up-down direction orthogonal to the front-rear direction and a left-right direction orthogonal to the front-rear direction, at a center of the power tool in the left-right direction; and
a plurality of the elastic mechanisms are provided on both sides of the grip portion in the left-right direction.
